(19) United States
(12) Patent Application Publication
(10) Pub. No.: US 2010/0049633 A1
(43) Pub. Date: Feb. 25, 2010

(54) SYSTEM AND METHOD TO IDENTIFY AND VISUALLY DISTINGUISH PERSONALLY RELEVANT ITEMS

(75) Inventors: Louise S. Wannier, Pasadena, CA (US); James P. Lambert, Toluca Lake, CA (US); Mercedes De Luca, Saratoga, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: myShape, Inc., Glendale, CA (US)

(21) Appl. No.: 12/545,336

(22) Filed: Aug. 21, 2009

Related U.S. Application Data
(60) Provisional application No. 61/091,334, filed on Aug. 22, 2008.

(51) Int. Cl. G06Q 30/00; G06F 3/048

(52) U.S. Cl. 705/27; 715/825

(57) ABSTRACT

An improved online shopping system is described herein, wherein a shopper is provided with a differentiated display of items, thereby allowing the user to discern which items match a “personal shop” criteria, among items that might not match that “personal shop” criteria.

### CROSS-REFERENCE TO RELATED APPLICATIONS

This application claims benefit under 35 USC §119(e) of U.S. Provisional Patent Application No. 61/091,334 filed Aug. 22, 2008, which is herein incorporated by reference in its entirety for all purposes.

The present disclosure may be related to the following commonly assigned applications/patents:
U.S. Pat. No. 7,398,133 entitled “Matching the Fit of Individual Garments to Individual Consumers” issued to Wannier et al. (hereinafter “Wannier I”);
U.S. patent application Ser. No. 11/697,688 filed Apr. 6, 2007, entitled “Computer System for Rule-Based Clothing Matching and Filtering Considering Fit Rules and Fashion Rules” in the name of Wannier et al. (hereinafter “Wannier II”), published as U.S. Patent Publication 2007/0198120 published Aug. 23, 2007;
U.S. patent application Ser. No. 12/433,830 filed Apr. 30, 2009, entitled “System and Method for Networking Shops Online and Offline” in the name of Wannier et al. (hereinafter “Wannier III”);
U.S. patent application Ser. No. 12/494,242 filed Jun. 29, 2009, entitled “System and Method for Networking Shops Online and Offline” in the name of Wannier et al. (hereinafter “Wannier IV”);
U.S. patent application Ser. No. 12/494,244 filed Jun. 29, 2009, entitled “System and Method for Networking Shops Online and Offline” in the name of Wannier et al. (hereinafter “Wannier V”); and

U.S. patent application Ser. No. 12/510,198 filed Jul. 27, 2009, entitled A Distributed Matching System for Comparing Garment Information and Buyer Information Embedded in Object Metadata at Distributed Computing Locations Offline” in the name of Wannier et al. (hereinafter “Wannier VI”).

The respective disclosures of these applications/patents are incorporated herein by reference in their entirety for all purposes.

### FIELD OF THE INVENTION

The present invention relates to computer systems, local, centralized or distributed, for providing consumer access to databases of clothing items and in particular to computer systems that programmatically match clothing items with individual consumers' data, possibly including searching, sorting, ranking and filtering database items so that the computer system can be customized for different users to provide custom shopping experiences.

### BACKGROUND OF THE INVENTION

As more and more consumers rely on electronic online access to information about products for purchase, more and more merchants will need to consider providing electronic access to information about goods and services available to those consumers. In a typical electronic commerce situation, a merchant compiles a database of their products and/or services, possibly including information about each product (size, color, type, description, price, etc.). Then the merchant provides consumers with an external electronic interface to that database, such as through a Web server, giving access to those consumers with Internet connectivity on their computers, computing devices, or telecommunication devices. Consumers can then review the merchant's available offerings, select items of interest, and even order them by interacting with the merchant's interface (e.g., selecting items and quantities, arranging for payment, arranging for delivery, etc.).

Online shopping is more remote and less physical than in person shopping, as computers and computer displays are limited in what they can provide to the potential consumer. For example, the consumer will not be able to feel, smell, hold or manipulate the actual product being ordered. These shortcomings are not an issue where the consumer knows the product and it is unchanging. For example, when the consumer is ordering a specific book by title known to the consumer or a familiar bag of pet food, all the consumer really needs is minimal information, and possibly a photo of the item, to ensure that they are ordering the specific item they had in mind. However, with some other classes of goods, online ordering has been somewhat limiting.

For example, when ordering items of clothing, online shopping has significant limitations. For one, because consumers rarely buy the exact same article of clothing over and over, they often do not have specific clothing items in mind while shopping, such as a particular brand, size, color, etc. of pants. More typically, a consumer is purchasing some item of clothing he or she does not already have an exact copy of, so there may be a question of how that item might fit and look when worn by that consumer.

With some clothing items, fit can be inferred from a description. For example, the fit for a belt that is 38 inches long and one inch wide might be inferred from that description alone. However, for other items, such as a dress, fit might not be so straightforward and in some cases, the best approach is for the consumer to physically have the item and try it on, which is impossible with online shopping. Another difficulty is the wide variety of clothing items that can include garments, accessories, shoes, belts, etc. The complexity of online shopping is further compounded for the consumer trying to assemble an outfit, that is, a set of two or more clothing items intended to be used or worn together.

A number of approaches have been tried to bridge the gap between online shopping for clothing items and having the item in hand to try on.

One approach is to take measurements from the consumer, assume other measurements, and then custom make the desired clothing item according to tailoring assumptions and/or standard models. Because of the wide variety of human body shapes and garment types this may work well for some people but not others.

Another approach is to have clothing items represented by geometric models: scan an image of the consumer (or the consumer herself), and then use computer graphics techniques to generate a combined image of the consumer and a geometric model of a garment in an attempt to show a simulation of how that consumer might look, if she were actually wearing that garment. Such an approach takes time and might require the consumer to “virtually” try on a great many clothing items—one after another.

Online apparel shopping results in greater percentages of returns compared with purchases made at a physical store. Most of the return rate for women's clothing sold in the U.S. is due to size and fit problems.

One cause of fit problems is a lack of standards. The U.S. Department of Commerce withdrew the commercial standard for the sizing of women's apparel in 1983, and since then clothing manufacturers and retailers have repeatedly redefined the previous standards or invented their own proprietary sizing schemes. The garment size for an individual often differs from one brand of apparel to another and from one style to another. This is commonly seen with women's clothing. A dress labeled “size 10” of a particular style from one manufacturer fits differently than a size 10 from another manufacturer or perhaps even a different style from the same manufacturer. One may fit well, the other not at all. Even within a single size from a single manufacturer, there can be fit problems caused by the wide variation in consumers' body shapes. Consumers typically must try on multiple garments before finding and buying one that fits.

There are more than 5,000 designers and each of them might use a particular body fit model that represents a different body proportion and change these models from season to season and style to style. Thus, what fits changes based on designer, style of garment, season, and can also change with different fabrics and weaves and washes.

The lack of sizing standards combined with unreliable labeling cause apparel fit problems, which in turn cause a very high rate of apparel returns, lost sales, brand dissatisfaction, time wasted in fitting rooms, and intense consumer frustration. The problems are only compounded when consumers attempt to make clothing purchases online instead of trying on actual clothing items in a bricks and mortar store.

Another attempt to deal with these problems involves analyzing a wide range of a market population and then designing a range of body shapes and designs for a particular garment based on that population. For example, manufacturers might be directed to produce several shapes of a particular pant to offer different fit choices in pants given what the population for the market for such pants is estimated at. The problem is that this approach still relies on the trial and error of locating that pant and determining individually whether it is a good match.

In the field of online shopping, it is known to use an individual's measurements, shape, profile, etc. to filter through a listing of items for sale, such as garments and accessories, to show the individual only those items that fit and/or flatter based on some determination made from the items' measurements, shape, profiles, etc. and the individual's measurements, shape, profile, etc. Thus, the individual can be provided with a “personal shop” showing only the matching items that are personally relevant to the individual. Of course, the same process can be used for someone else shopping for the individual if that individual's parameters are available to the presentation and processing system that generates the views for the personal shop. An example of such a system that provides for a personal shop is the system developed by myShape, teachings of which are shown in Wannier I and Wannier II.

The personal shop generating system might obtain the individual's data by setting up an account for that individual, storing user data, associating the user's personal shop with that user once the user authenticates to the system, or similar techniques. This process, however, might be complicated when the user is browsing a retail shopping website that does not have personal shop functionality or the system serving that website does not know the user (for example, where the user has not logged in to that system, does not want to log in to that system, or where the system does not maintain user accounts). In those cases, the shopping website is often limited to showing generic selections of items.

Additional complications may arise when a shopper wanders the aisles of a “bricks and mortar” store. In such cases the retail store is necessarily limited to displaying items on its sales floor in an impersonal fashion; that is, numerous clothing items that fit or suit many people are all commingled. At best items may be grossly organized by type (blouses, pants, etc.), brand and/or size. A shopper must spend time and effort to actively seek out and try on clothes in the hope of finding items that match her own measurements and preferences. There is nothing personal about the arrangement of such a store nor the shopping experience therein.

What is needed is a system and method for identifying items for sale on a shopping website that are personally relevant to the user when said website does not have personal shop functionality, or where the site does not maintain user accounts, or where the user has not logged into the shopping website.

What is further needed is a method to create differentiated views of items for sale to visually distinguish personally relevant items from those which are not relevant to the user/shopper. In a differentiated view, matching items are shown one way and non-matches are shown a different way, such that the user or user software can easily tell the difference.

What is further needed is a system and method for identifying items for sale in a physical store that are personally relevant to the shopper and “match” her profile, so that she can quickly find the items, clothes and fashion products that fit, suit and flatter her.

### BRIEF SUMMARY OF THE INVENTION

An improved online shopping system is described herein, wherein a shopper is provided with a differentiated display of items, thereby allowing the user to discern which items match a “personal shop” criteria, among items that might not match that “personal shop” criteria. The criteria are specified as part of the shopper's (or the ultimate user's, where the shopper is shopping for the use of someone else) personal shop profile.

The following detailed description together with the accompanying drawings will provide a better understanding of the nature and advantages of the present invention.

### BRIEF DESCRIPTION OF THE DRAWINGS

FIG. 1 is an illustration of a clothes shopping system, in accordance with described embodiments.

FIG. 2 is a simplified block diagram of a consumer-garment matching method, in accordance with described embodiments.

FIG. 3 is a simplified block diagram of a definition process, in accordance with described embodiments.

FIGS. 4A-D illustrate height and length measurement techniques, in accordance with described embodiments.

FIGS. 5A-B are simplified block diagrams of a categorization process, in accordance with described embodiments; FIG. 5A shows a consumer recording process and FIG. 5B shows a garment recording process.

FIG. 6 is a simplified block diagram of a match assessment process, in accordance with described embodiments.

FIGS. 7-13 include flowcharts illustrating a match assessment process for a fitted dress, in accordance with described embodiments.

FIG. 14 is an illustration of example output from a match assessment process, in accordance with described embodiments.

FIG. 15 is an illustration of a garment display interface, in accordance with described embodiments.

FIGS. 16-18 are illustrations of clothes shopping systems, in accordance with described embodiments.

FIG. 19 is a block diagram of a linked lists creation process in accordance with described embodiments.

FIG. 20 is an illustration of a clothes shopping system, in accordance with described embodiments.

FIG. 21 is a block diagram of an outfit presentation process in accordance with described embodiments.

FIGS. 22-24 are block diagrams of a body shape, consumer, and garment categorization processes, in accordance with embodiments of the invention.

FIG. 25 is an illustration of a match system, in accordance with embodiments of the invention.

FIG. 26 is an illustration of a clothes shopping system, in accordance with described embodiments.

FIG. 27 is a block diagram of a preferred fashion presentation process in accordance with described embodiments.

FIGS. 28-30 are block diagrams of a fashion product and accessory presentation and recommendation processes in accordance with described embodiments.

FIG. 31 is a block diagram of an altered garment presentation process in accordance with described embodiments.

FIG. 32 is a block diagram of a garment profiling process in accordance with described embodiments.

FIG. 33 is an illustration of a clothes shopping system, in accordance with described embodiments.

FIGS. 34-36 are block diagrams of a user shopping update process in accordance with described embodiments.

FIG. 37 illustrates metadata structure of a garment image and of a consumer image.

FIG. 38 illustrates an exemplary searching process

FIG. 39 illustrates an exemplary process for the metadata use of RFID tags.

FIG. 40 is an illustration of a clothes shopping system, in accordance with described embodiments.

FIG. 41 is a block diagram of a differentiated views creation process in accordance with described embodiments.

FIG. 42 is a block diagram of a differentiated views creation process in accordance with described embodiments.

FIG. 43 is an illustration of differentiated view techniques, in accordance with described embodiments.

FIG. 44 is a block diagram of a process to identify matching items in accordance with described embodiments.

These and other embodiments of the invention are described in further detail below.

### DETAILED DESCRIPTION

An improved online clothes shopping system is described herein, where a consumer is presented with a personalized online store that lists clothing items for sale that are most likely to fit and flatter that particular consumer and match that consumer's preferences for style and fit. The presented list of items is generated by a computerized garment-consumer matching method that matches the fit and fashion of individual clothing items to individual consumers. In embodiments of the system, a shopper is provided with a differentiated display of items, thereby allowing the user to discern which items match a “personal shop” criteria, among items that might not match that “personal shop” criteria. It should be understood that references to “shopper” include agents, friends, associates, family members, etc. who are shopping for the ultimate user/wearer/consumer of the items being shopped for. For example, where person A is shopping for a dress as a gift for person B, the personal shop profile that is being used by the computer to form displays, compute and interact with person A is actually the personal shop profile of person B. For brevity, this will not be repeated each time, but it should be understood that the appropriate personal shop profile is used at the appropriate time.

According to aspects of the present invention, elements and embodiments can be provided in part by novel components, implemented in software, hardware and/or network protocols.

Clothing items are commonly thought to include garments (dresses, coats, pants, shirts, tops, bottoms, socks, shoes, bathing suits, capes, etc.), but might also include worn or carried items such as necklaces, watches, purses, hats, accessories, etc. In any of the following examples, sized and fitted garments are the items being shopped for, but it should be understood that unless otherwise indicated, the present invention may be used for shopping for other clothing items as well. As used herein, an outfit is a collection of two or more clothing items intended to be worn or used together.

In describing embodiments of the invention, female consumers and women's apparel will serve as examples. However, the invention is not intended to be limited to women's apparel as the invention may be used for various types of apparel including men's and children's apparel. Throughout this description the embodiments and examples shown should be considered as exemplary rather than limitations of the present invention.

In a matching process, garments and consumers are compared. For garments, the garment measurements, garment style/proportion and garment attributes (color, weave, fabric content, price, etc.) might be taken into account, while for the consumer, consumer measurements, consumer body proportion (such as shape code), and consumer fit and style and fashion preferences (how snug/loose, color, classic/contemporary/romantic, etc.), might be taken into account.

Fashion rules can be defined for various garment style(s) that suit a particular body proportion, both for garments and for outfits, including accessorizing. Fashion rules (programmatically defining fashion expertise) can be “overlaid” on the matches to recommend the best combinations that will fit and flatter. In this manner, a consumer might be presented with a large number of garments to choose from, but each would be more likely to be a “good choice”, while leaving out those garments that are less likely to fit or flatter. There could be a wide variety of garments and styles, etc., but organized as a personal store for that consumer.

### Clothes Shopping System

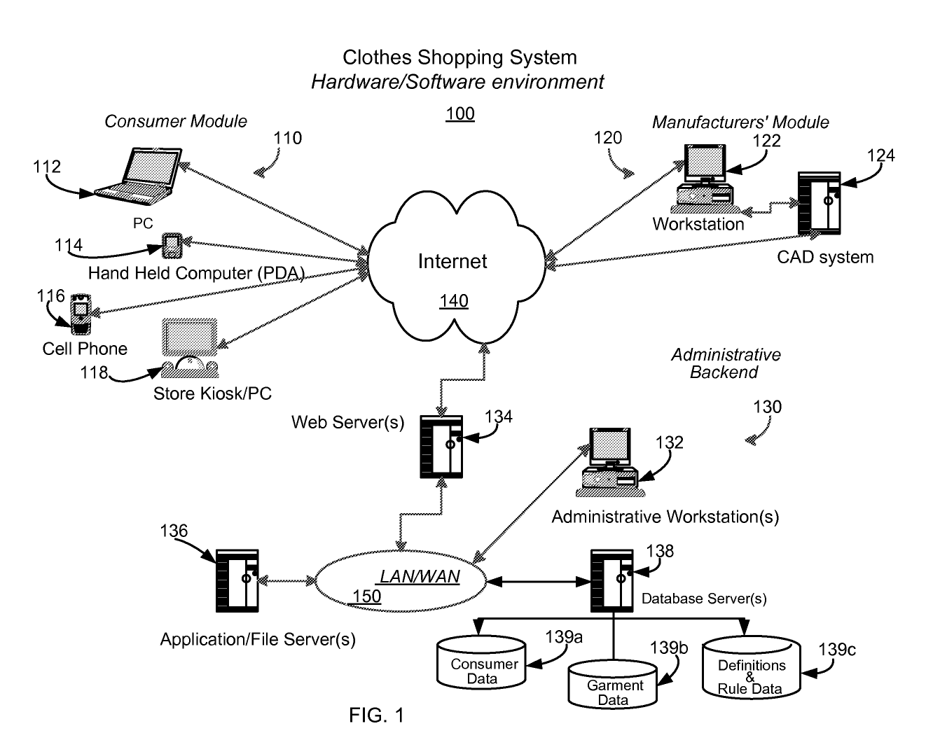

FIG. 1 is a high-level diagram depicting a clothes shopping system 100, which is a computer implementation of a consumer-garment matching method in accordance with one embodiment of the present invention. The clothes shopping system is a client-server system, i.e., an assemblage of hardware and software for data processing and distribution by way of networks, as those with ordinary skill in the art will appreciate. The system hardware may include, or be, a single or multiple computers, or a combination of multiple computing devices, including but not limited to: PCs, PDAs, cell phones, servers, firewalls, and routers.

As used herein, the term software involves any instructions that may be executed on a computer processor of any kind. The system software may be implemented in any computer language, and may be executed as compiled object code, assembly, or machine code, or a combination of these and others. The software may include one or more modules, files, programs, and combinations thereof. The software may be in the form of one or more applications and suites and may include low-level drivers, object code, and other lower level software.

The software may be stored on and executed from any local or remote machine-readable media, for example without limitation, magnetic media (e.g., hard disks, tape, floppy disks, card media), optical media (e.g., CD, DVD), flash memory products (e.g., memory stick, compact flash and others), Radio Frequency Identification tags (RFID), SmartCards™, and volatile and non-volatile silicon memory products (e.g., random access memory (RAM), programmable read-only memory (PROM), electronically erasable programmable read-only memory (EEPROM), and others), on paper (e.g., printed UPC barcodes). In some embodiments, the software is stored in smart textile material, embedded in intelligent clothing and/or wearable electronics.

Data transfer to the system and throughout its components may be achieved in a conventional fashion employing a standard suite of TCP/IP protocols, including but not limited to Hypertext Transfer Protocol (HTTP) and File Transfer Protocol (FTP). The eXtensible Markup Language (XML), an interchange format for the exchange of data across the Internet and between databases of different vendors and different operating systems, may be employed to facilitate data exchange and inter-process communication. Additional and fewer components, units, modules or other arrangement of software, hardware and data structures may be used to achieve the invention described herein. An example network is the Internet, but the invention is not so limited.

In one embodiment, a clothes shopping system 100 comprises three interconnecting components: a consumer module 110, a manufacturer module 120, and an administrative backend 130. These three components can all be operated over a network such as local and/or wide area networks (LAN/WAN) 150, and the Internet 140. In some embodiments, the clothes shopping system is present in a portable device that a shopper uses in a store that can interact with the items for sale in that store and/or a database of items that is usable by the shopper's device. In such cases, no networking might be needed at all.

The administrative backend 130 uses administrator workstations 132, web servers 134, file and application servers 136, and database servers 138. The backend houses the consumer-garment matching software, the consumer and garment record databases 139a-139b, definition & rules database 139c, and the online store website with all of its necessary ecommerce components, such as Webpage generators, order processing, tracking, shipping, billing, email and security. Administrator workstations allow for the management of the entire system and all of its parts, including the inputting and editing of data.

The manufacturer module 120 uses software/hardware that allows a manufacturer to input data into the garment records that represent the garments the manufacturer makes. For example, for each garment of a particular size or SKU, a manufacturer enters the garment's dimensional measurements and profile data into the manufacturer module. This data may be entered manually via a workstation 122 or automatically by interfacing with the manufacturer's own internal systems, such as CAD systems 124 and PLM (product lifetime management) systems, and/or pattern making systems. This inputted garment data might then be subjected to the garment categorization process 220, as described herein.

Additionally, the module may provide the manufacturer with computed output from the system, such as the shape codes of their various garments. The manufacturer may now employ the system's output in his manufacturing process; for example, to print shape code(s) on a garment's label or sales tag, or to electronically embed part or all of a garment's record in its RFID tag. In some embodiments, a shopper's device will signal when some item meets the “fit and flatter” requirement as determined by the consumer module or as determined by a remote system performing the matching process.

The consumer module 110 is typically accessed by consumers via personal computers at home, school or office 112. The consumer module 110 may also be accessed through cellular phones 116, PDAs 114 and other networked devices, such as kiosks 118 in retail stores at malls, shopping centers, etc. It is through the consumer module 110 that a consumer can input her measurements, preferences and profile data into her consumer record. This inputted consumer data might then be subjected to the consumer categorization process 220, as described herein. And importantly, the consumer module enables the consumer to shop and buy at her personalized online clothes store.

Data such as consumer and garment records, that normally are input via the consumer and manufacturer modules, might also be input and edited via the administrative backend 130.

### The Consumer-Garment Matching Method

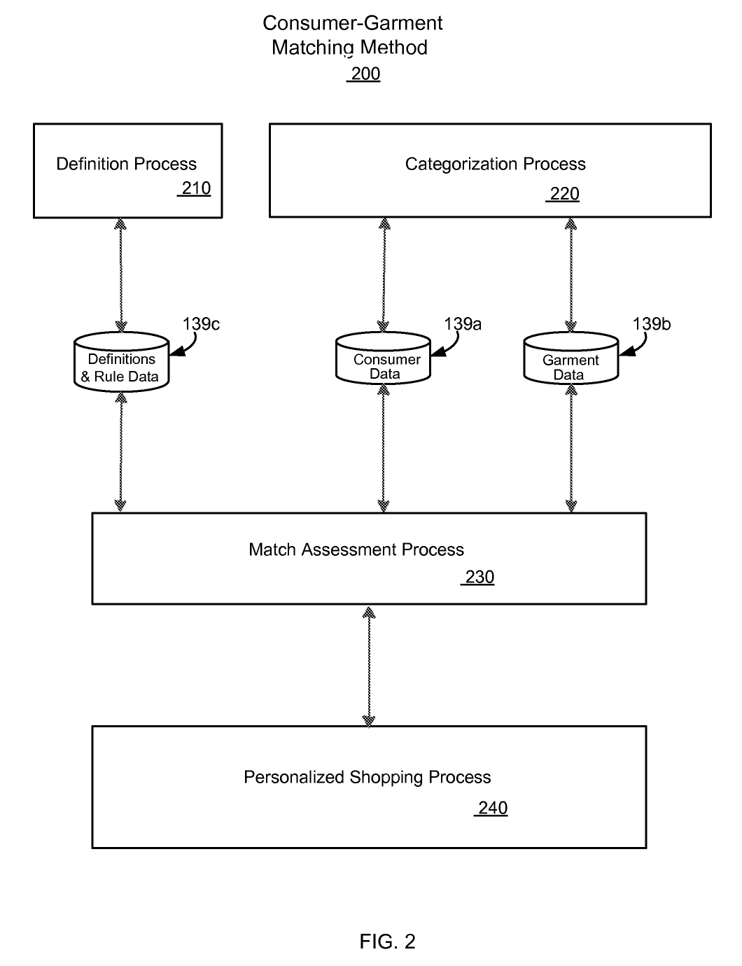

FIG. 2 is a simplified block-diagram depicting a consumer-garment matching method 200 and the data inputs, outputs and interdependence of its constituent processes: a definition process 210, a categorization process 220, a match assessment process 230, and a personalized shopping process 240, described herein.

### Definition Process

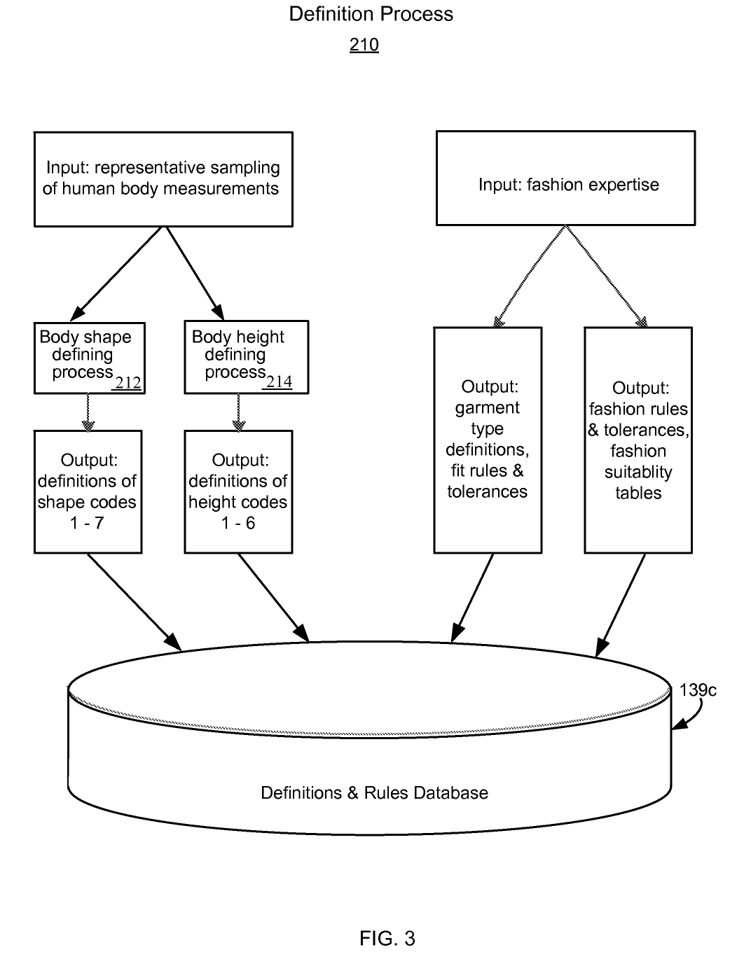

FIG. 3 depicts a definition process 210. The definition process defines a) human body shapes into a set of shapes (represented by shape codes 1 through 7 in this embodiment), b) human body heights into a set of heights (represented by height codes 1 through 6 in this embodiment), c) garment types (sixteen in this embodiment), d) fit rules, and e) fashion rules.

Prior to defining either human body shapes or human body heights, it is first necessary to determine a list of critical measurements of the human body. Table 1 lists twenty one such measurements as used in one embodiment of the present invention. Other embodiments may use more, fewer or different body measurements. A similar or identical set of measurements may also be used by the categorization process 220 when collecting body measurement data from any individual consumer via the consumer module 110. Note: The measurement reference numbers appearing in Table 1 will be subsequently used throughout this document to concisely write formulae. The lowercase “c” (for consumer) denotes these measurements are provided by the consumer, such as might result from personal manual measurements.

TABLE 1
Body Measurements

| Measurement Name | Meas. Ref. # |
|---|---|
| Shoulder Circumference | 1Cc |
| Bust Circumference | 2Cc |
| Waist Circumference | 3Cc |
| High Hip Circumference | 4Cc |
| Hip Circumference | 5Cc |
| Shoulder to Shoulder Front | 6Fc |
| Bust Front | 7Fc |
| Waist Front | 8Fc |
| High Hip Front | 9Fc |
| Hip Front | 10Fc |
| Top of Head Height | 11Hc |
| Shoulders Height | 12Hc |
| Bust Height | 13Hc |
| Waist Height | 14Hc |
| High Hips Height | 15Hc |
| Hips Height | 16Hc |
| Knee Height | 17Hc |
| Total Rise | 18Dc |
| Armhole Circumference | 19Dc |
| Inseam | 20Dc |
| Arm | 21Dc |

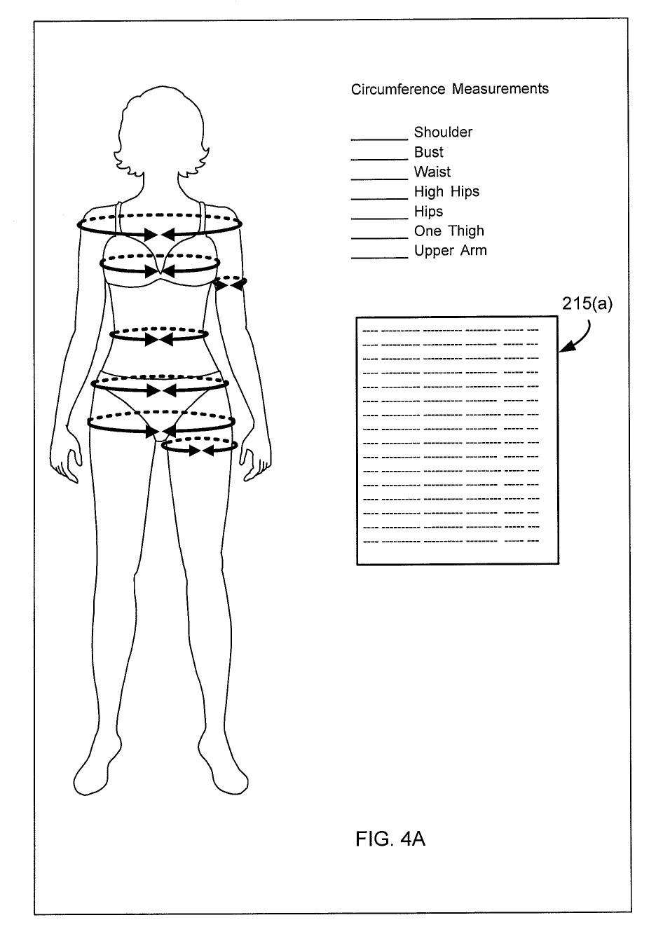

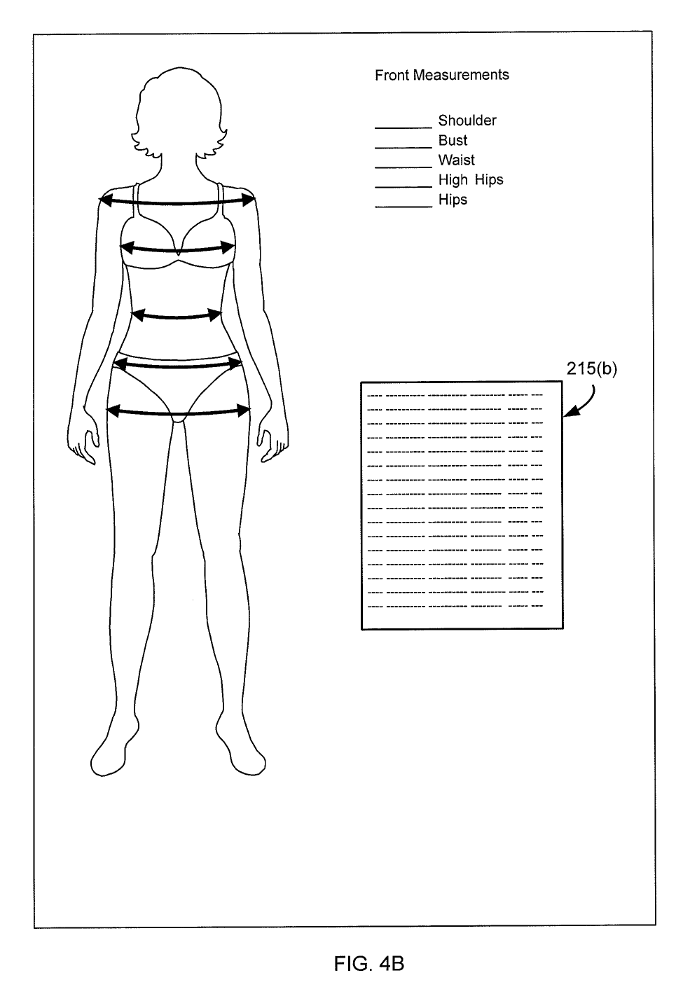

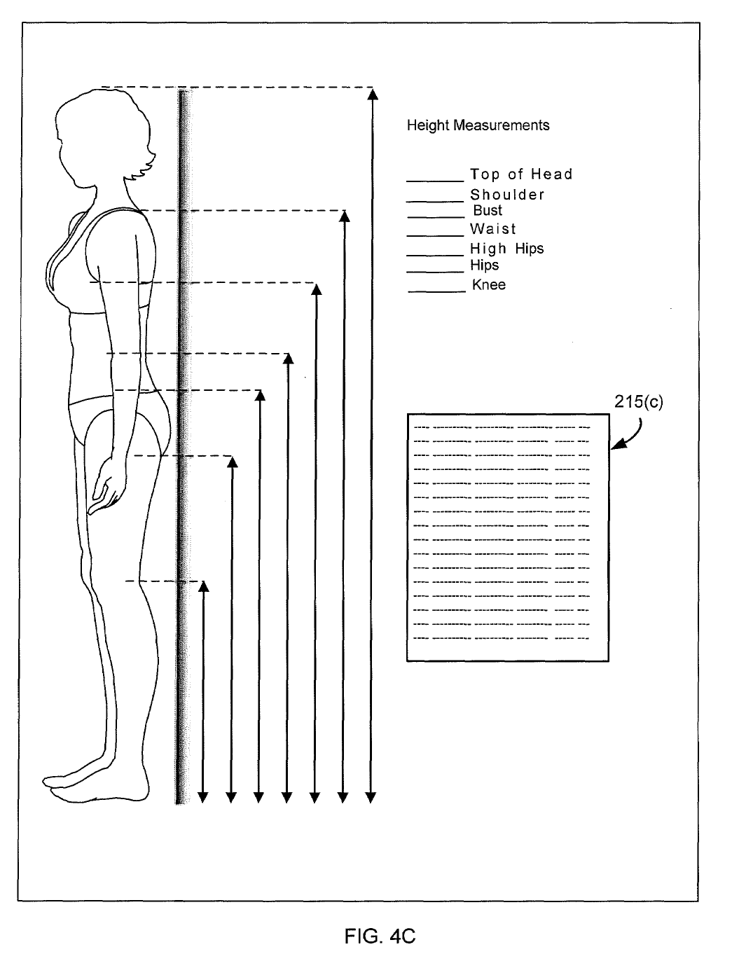

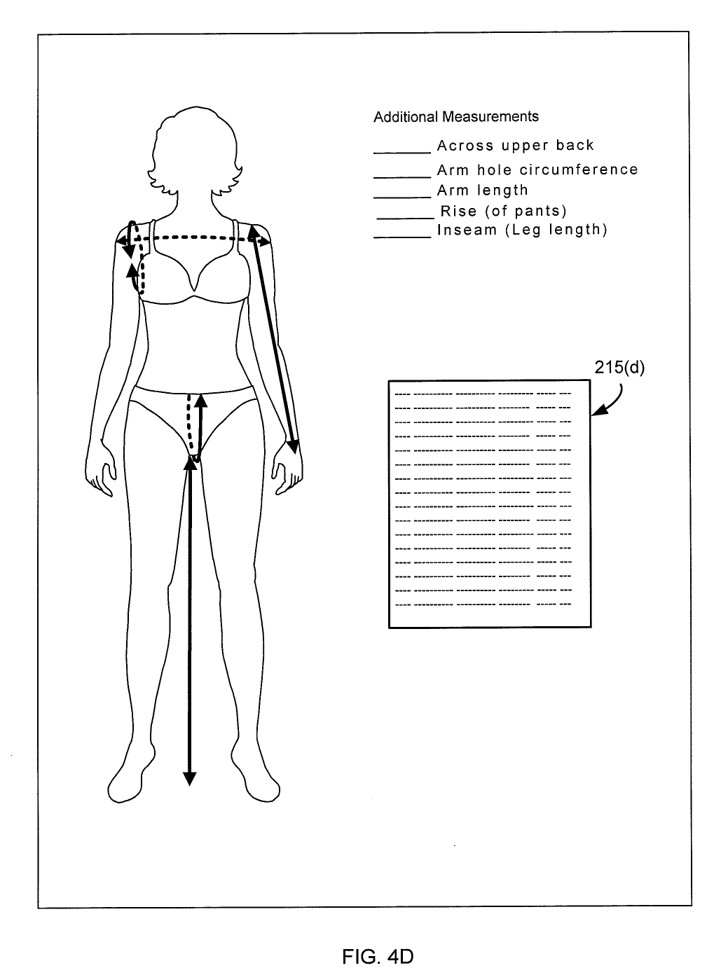

FIGS. 4A-4D depict the positions and techniques for acquiring body measurements to obtain consumer data shown in Table 1, as an example.

The displays of FIGS. 4A-4D might include instructions to the reader, as instruction blocks 215(a), 215(b), 215(c) and 215(d). Examples of instruction blocks are:

215(a) in FIG. 4A:
Measure the CIRCUMFERENCE of your body at various points.
Shoulders: Measure around shoulders, just below the shoulder joint, going outside your arms at the widest point.
Bust: Measure bust at fullest point and straight across back.
Waist: Measure around torso at your waistline.
High Hips Measure over top of hip bones, 2″-4″ below waist.
Hips: Measure at the fullest part, usually 7″-9″ from waist.
One Thigh: Measure at the fullest part of one thigh on one leg (your choice).
Upper Arm: Measure the circumference of the thickest part of your upper arm (that bicep muscle!).

215(b) in FIG. 4B:
Measure the FRONT OF YOU from the middle of one side to the middle of the other only. It helps if you are wearing lightweight, form fitting clothes with side seams to help locate the side of your body.
Front of Shoulders: Measure from mid point of upper arm just below the shoulder joint to the same point of the opposite side, crossing the front of your body.
Front of bust: Measure from as close to middle of one side of your body to the middle of the other crossing over the fullest part of your bust.
Front of Waist: Measure from middle of one side to the middle of the other at your waist.
Front of High Hips: Measure over top of hip bones, 2″-4″ below waist.
Front of Hips: Measure from the middle of one side to the middle of the other at the fullest part of your hips, usually 7″-9″ from waist.

215(c) in FIG. 4C:
Measure the HEIGHT of the following by taping or attaching a measuring tape to the bottom of a wall or doorway (floor—measurement zero) to measure the heights. A book, ruler or straight edge can help. This will give a vertical silhouette.
Top of head: Measure from the floor to the top of your head.
Should height: Measure from the floor to the top of your shoulder joint.
Bust height: Measure from the floor to the fullest point of your bust.
Waist Height: Measure from the floor to your waistline.
High hip height: Measure from the floor to your high hip (your hip bone, usually 2″-4″ below your waist).
Hip height: Measure from the floor to the fullest point of your hips.
Knee height: Measure from the floor to the mid-point of your knee.

215(d) in FIG. 4D:
Almost done, just a few more!
Across upper back: Measure across your upper back from end of shoulder joint to end of shoulder joint. Or, for a shortcut, use a favorite jacket, measuring from shoulder seam to shoulder seam.
Arm hole circumference: Measure top of should under arm and back around to the top of the arm.
Arm length: Measure from the middle of the shoulder joint to the wrist joint, with slightly bent elbow.

Rise (of pants): Start at middle for your waist in back, pass tape measure between your legs and up to the middle of your waist in front. Do not pull tight on this measurement, and don't make it too loose. Keep comfort in mind and make sure you are measuring your body accurately. A shortcut is to measure your favorite pair of pants.
Inseam (leg length): Measure from the crotch to the floor on the inside of your leg. Or, for a shortcut, measure the inseam of your favorite pair of pants.

Human body shapes are defined by a body shape defining process 212. Similarly, the same sample body measurement data form the inputs of a body height defining process 214. Definitions of body shape codes and body height codes are stored in the definitions & rules database 139c as maintained by database server 138. Thus these body shape codes may then be assigned by the categorization process 220. A similar or identical set of measurements may be used by the categorization process 220 when collecting garment measurement data for any individual garment via the manufacturer module 120. A garment type definition table specifies the measurements, tolerances and order of calculation to be used by the measurement filter 232 during a match assessment 230. Garment type definitions together with their fit rules and tolerances are stored in a definitions & rules database 139c as maintained by database server 138. The Fashion rules, tolerances and fashion suitability tables are stored by the definition process 210 in a definitions & rules database 139c as maintained by database server 138.

### Categorization Process

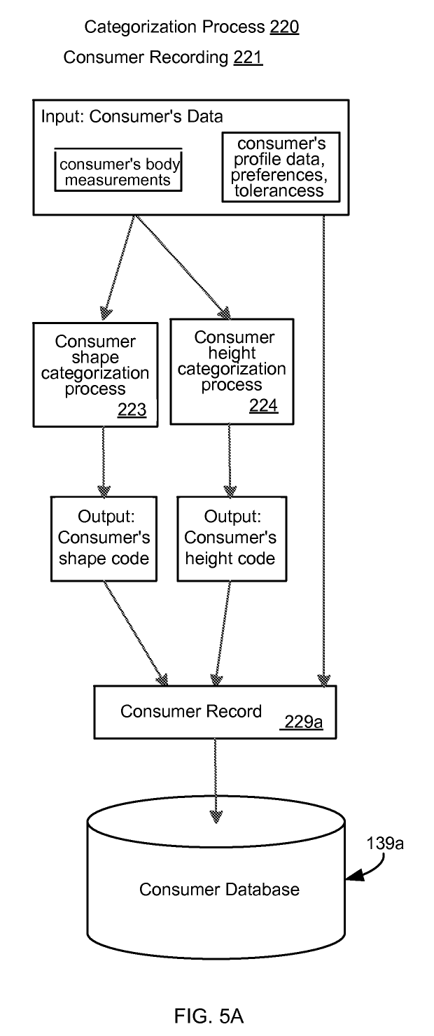

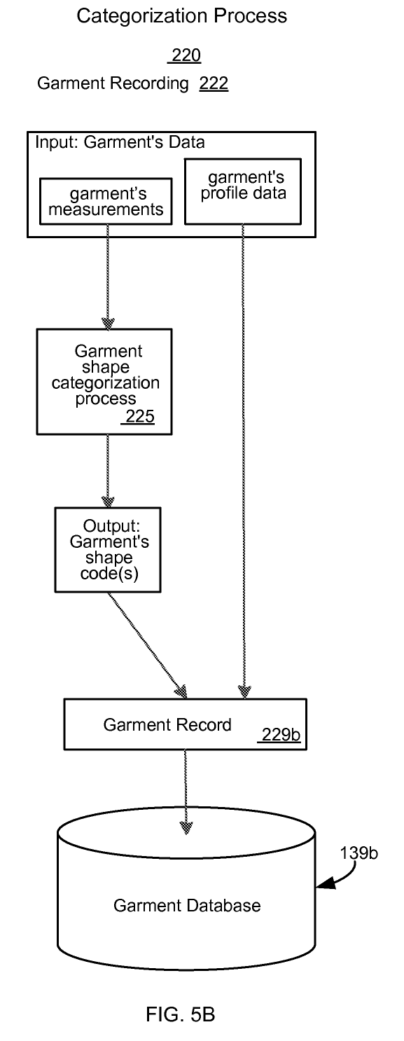

As embodied herein and depicted in FIGS. 5A-5B, a categorization process 220 has two sub-processes: consumer recording 221 (FIG. 5A) and garment recording 222 (FIG. 5B). A consumer record 229a is data describing an individual consumer. A garment record 229b is data describing an individual garment, including its measurements and profile, e.g., its color, fabric, tolerances, etc. The consumer records 229a are stored by the categorization process 220 in a consumer database 139a, while garment records 229b are stored in a garment database 139b. The consumer and garment databases are maintained by database server 138.

### Consumer Recording

An individual consumer's body measurements, such as those depicted in FIGS. 4A-4D, are input into a consumer shape categorization process 223. The resulting shape code is assigned to the consumer and stored in her record 229a. A consumer height categorization process 224 calculates a consumer's height code. The height categorization process is used to assign a height code to a consumer. The assigned height code can be stored in the consumer's record 229a.

### Garment Recording

The manufacturer module 120, described herein, supplies the garment measurements and profile data that form the inputs of the garment recording process 222. Referring again to FIGS. 5A-B, a garment's measurements are inputs to a garment shape categorization process 225. The resulting shape codes are assigned to the garment and stored in its garment record 229b. The consumer records 229a can be stored in a consumer database 139a, while garment records 229b can be stored in a garment database 139b. The consumer and garment databases can be maintained by database server 138.

### Match Assessment Process

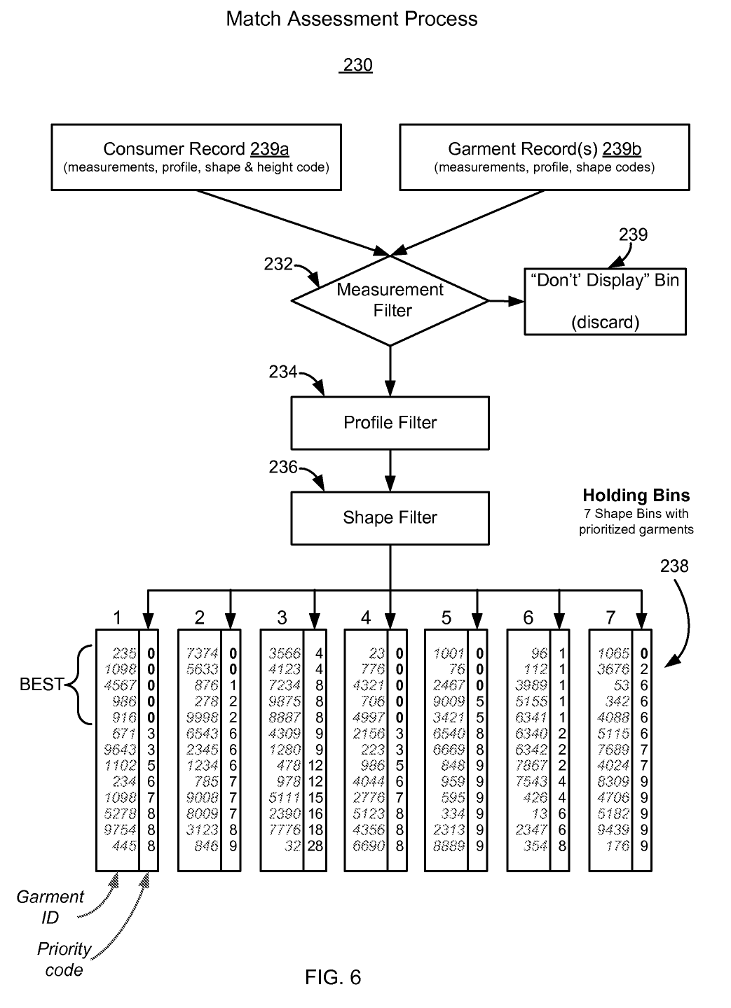

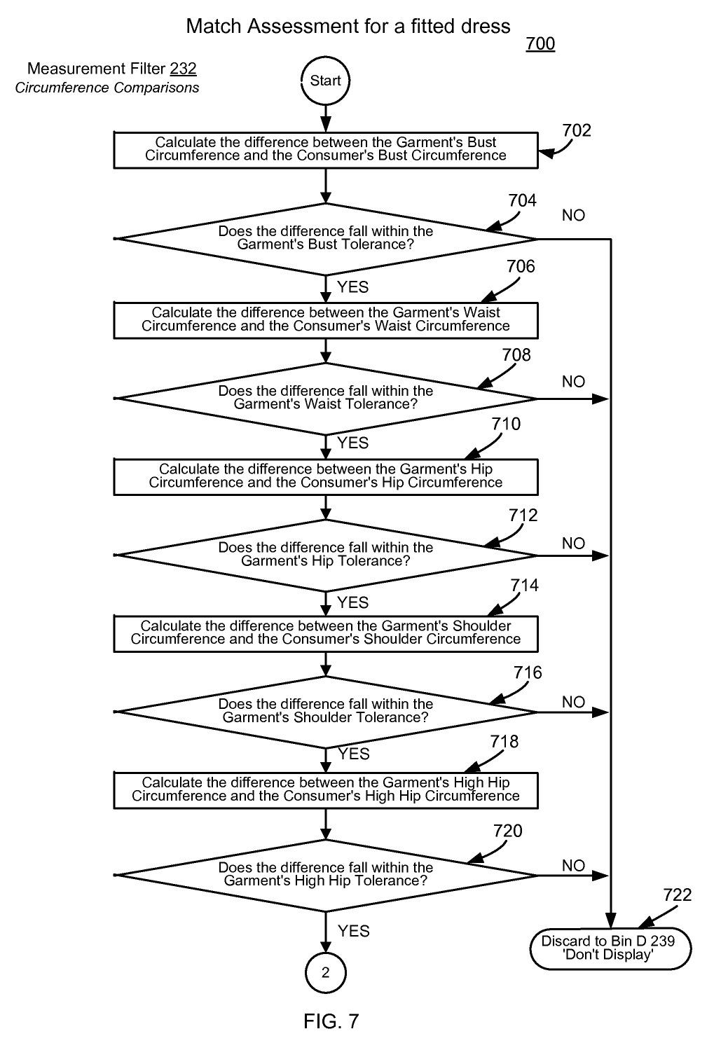

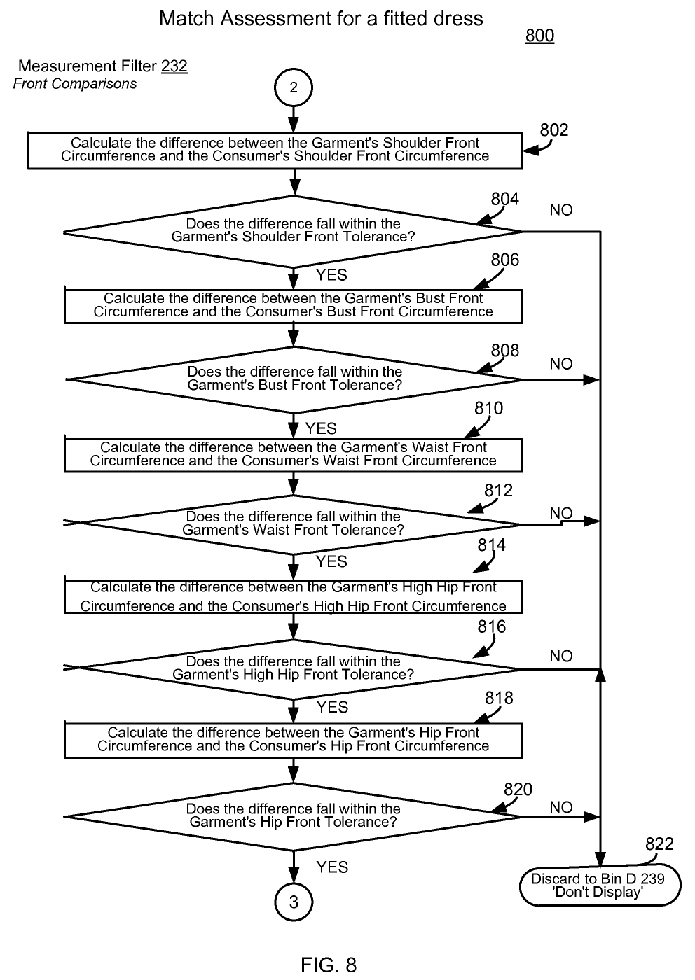

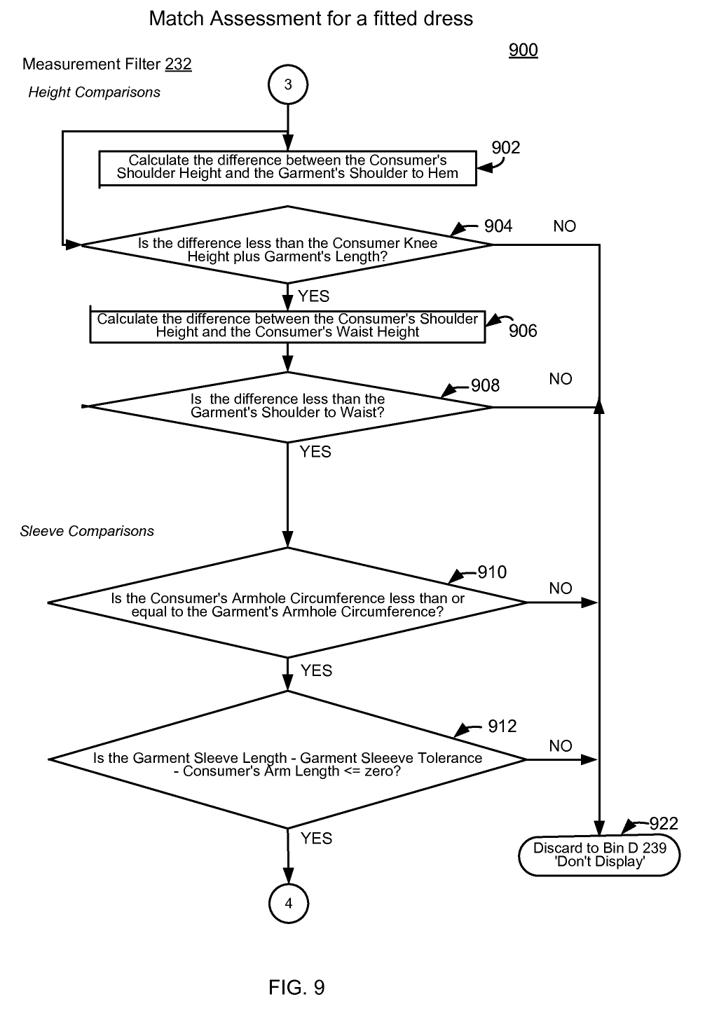

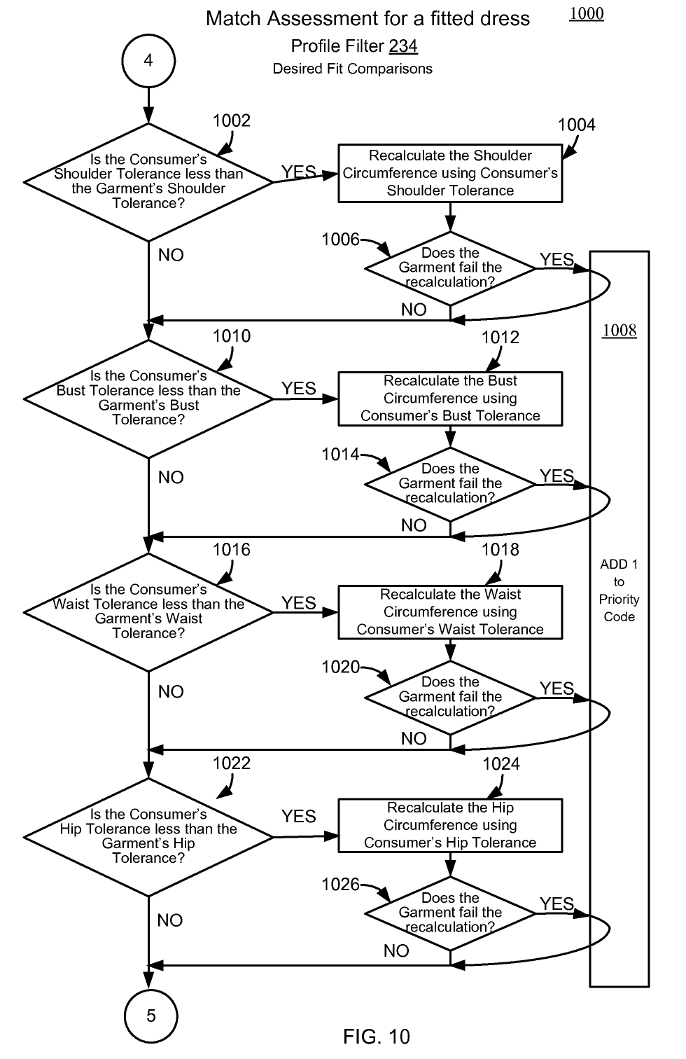

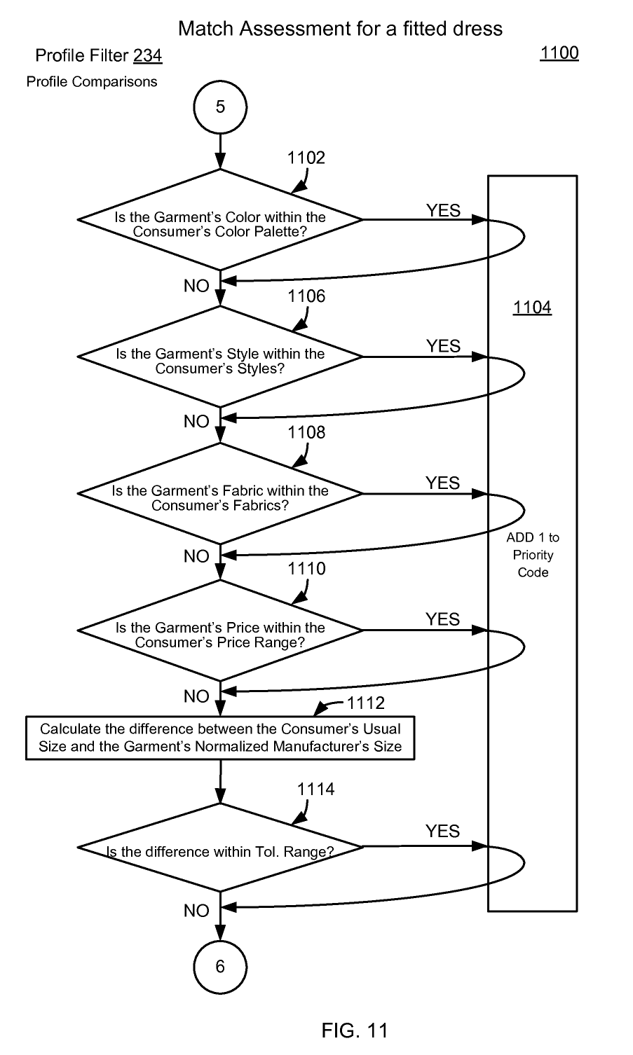

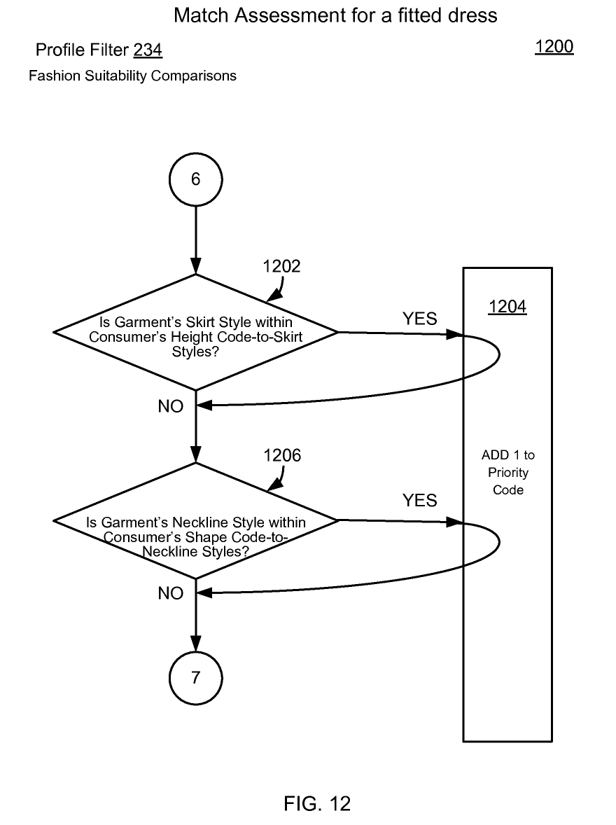

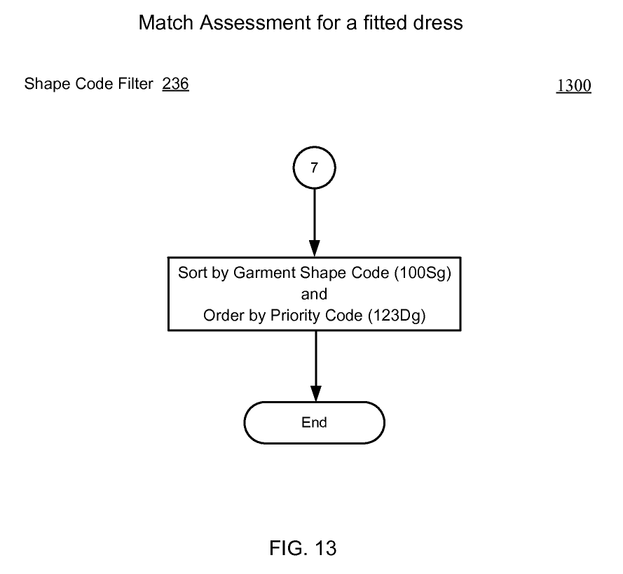

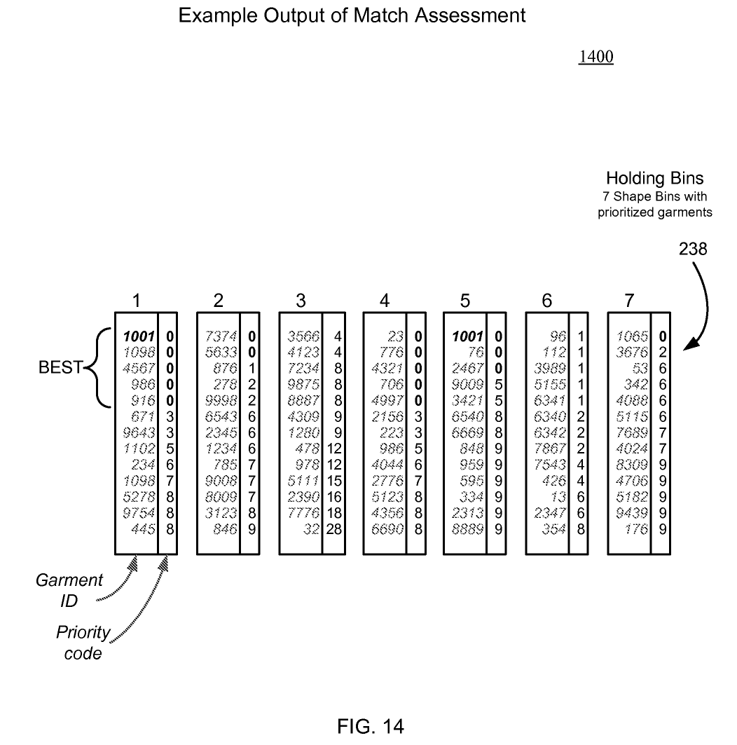

FIGS. 6-14 depict a match assessment process 230 and various elements thereof. The match assessment process treats both sewn clothing items and fashion accessories as garments. Thus it matches individual consumers with individual clothing items or individual accessories in the same manner and with equal efficacy. Further details of match assessment processes are taught in detail in Wannier I, II and/or III.

### Personalized Shopping Process

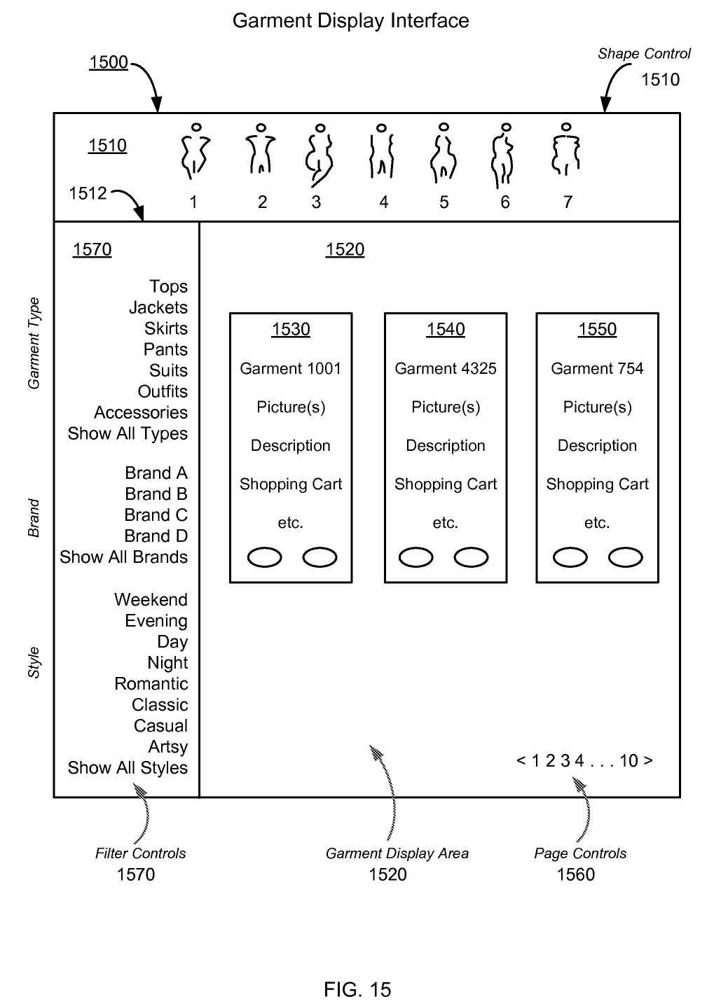

A personalized shopping process 240 presents a consumer with her personal online clothing store. In one embodiment, the consumer is presented with a personal store, which shows the customer garments, outfits and complementary accessories that match the customer's measurements, body shape, height code, personal preferences and fashion styling, that will fit her and flatter her as determined by the fashion suitability rules. In one embodiment, the results of a match assessment 230 of multiple garments and outfits may be displayed to the consumer using a graphical user interface (GUI) 1500 as depicted in FIG. 15. Further details of a personalized shopping process that might be used as the base for the present invention are taught in detail in Wannier I, II and/or III.

### Personal Mall

In addition to providing the consumer with a personalized store, elements of the systems described above can be expanded to cover a personal mall, wherein filtering is done as above, but over multiple online retail outlets. The particular retail outlets that are part of the system would depend on a number of criteria and the operator of the matching system might provide that access in exchange for commissions, as well as upselling, cross-marketing and providing other useful features for the consumer. An advantage to those retailers who join the personal mall and provide a virtual storefront is reduced return rates. With proper arrangement of the personal mall, each retail outlet can present its own brand and may be the shipper that ships the products directly to the consumer.

Among other teachings, a multi-partner shopping system is described that can be used for shopping for clothes and accessories, shoes, purses, and/or other products that include or embody notions of fashion and/or style. In one implementation, content is maintained on servers and served to browsers on request, with some content generated on the fly. The presentation of this material, collectively, by a server having access to the content is often referred to as a “website”, although the “location” of such a site is virtual and often in the minds of the users. Nonetheless, that shorthand is used herein and it should be understood that a website is content served by a physical computing system or a process running on a physical computing system. Likewise, when referring to operations that the “website” does or presents, it should be understood that those operations are performed by a processing device, processor, etc. executing instructions corresponding to the operations or perhaps specialized hardware, firmware or the like.

Online can refer to electronic communications and/or remote access of one computing system or device by another computing system or device, often those having client-server relationships. The access can be over a network of some sort or another. A common example used herein, but not intended to be limiting, is the Internet.

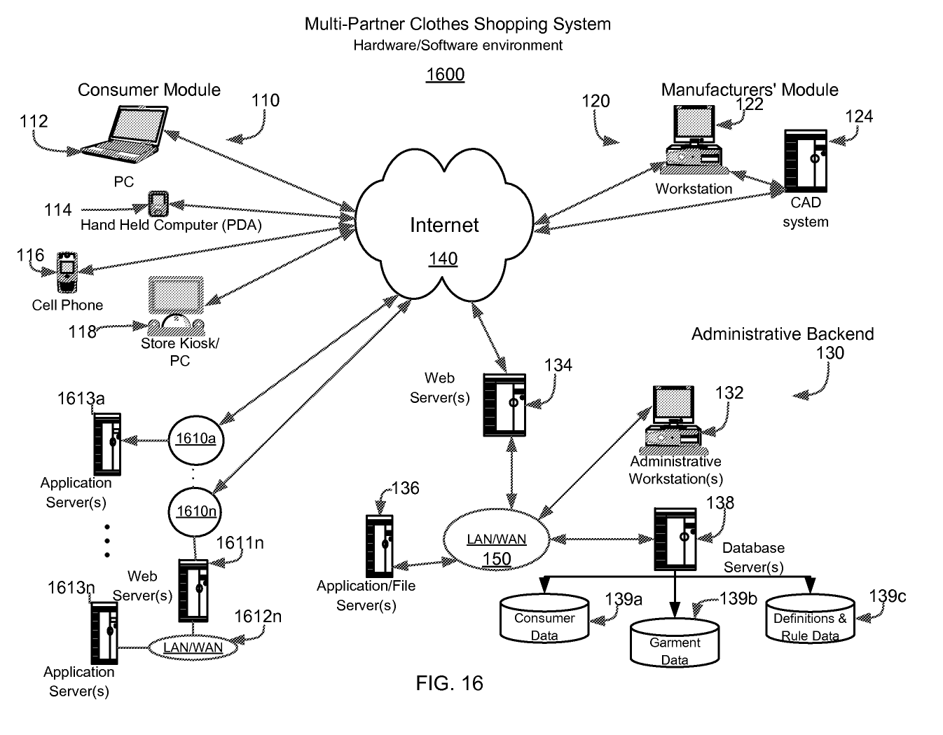

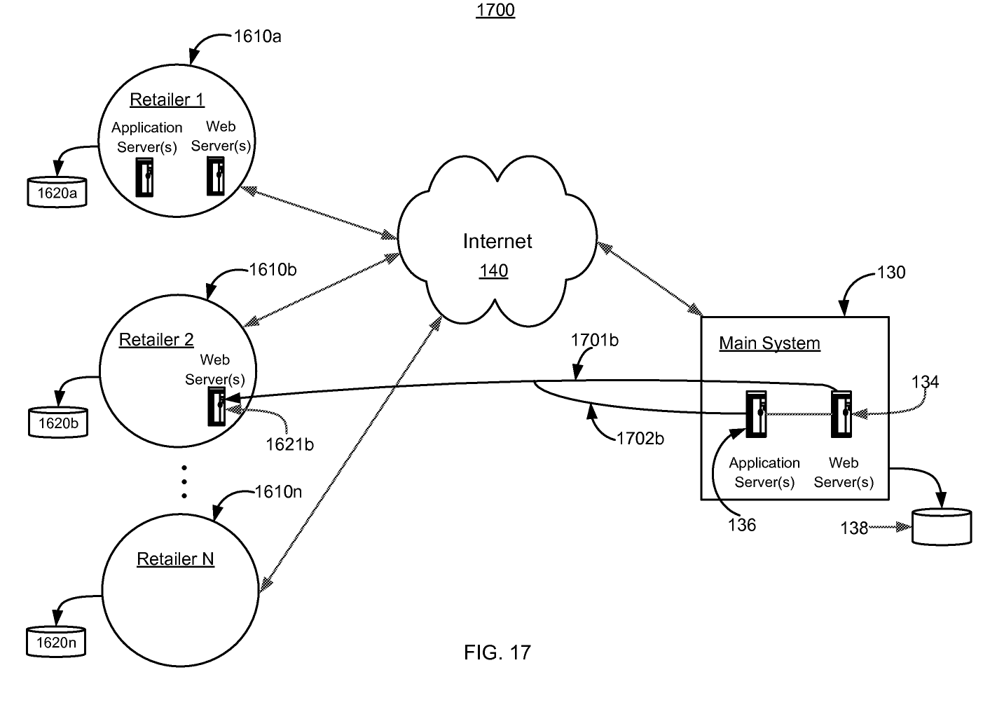

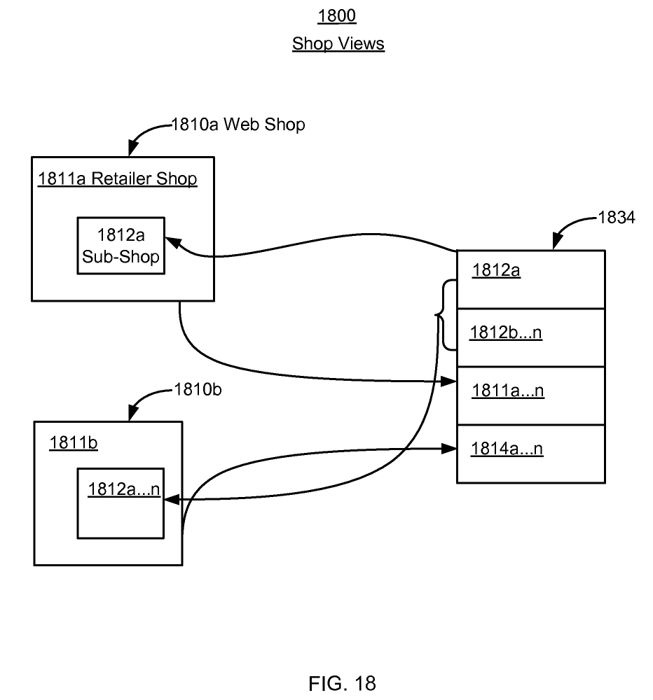

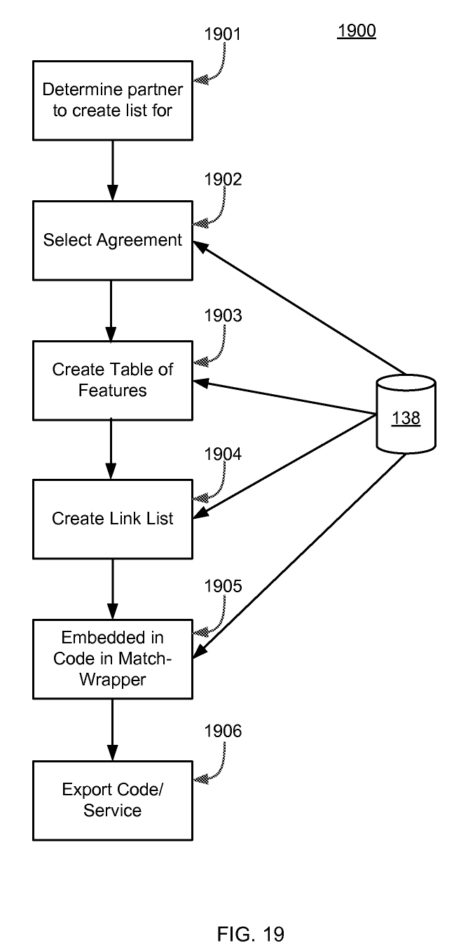

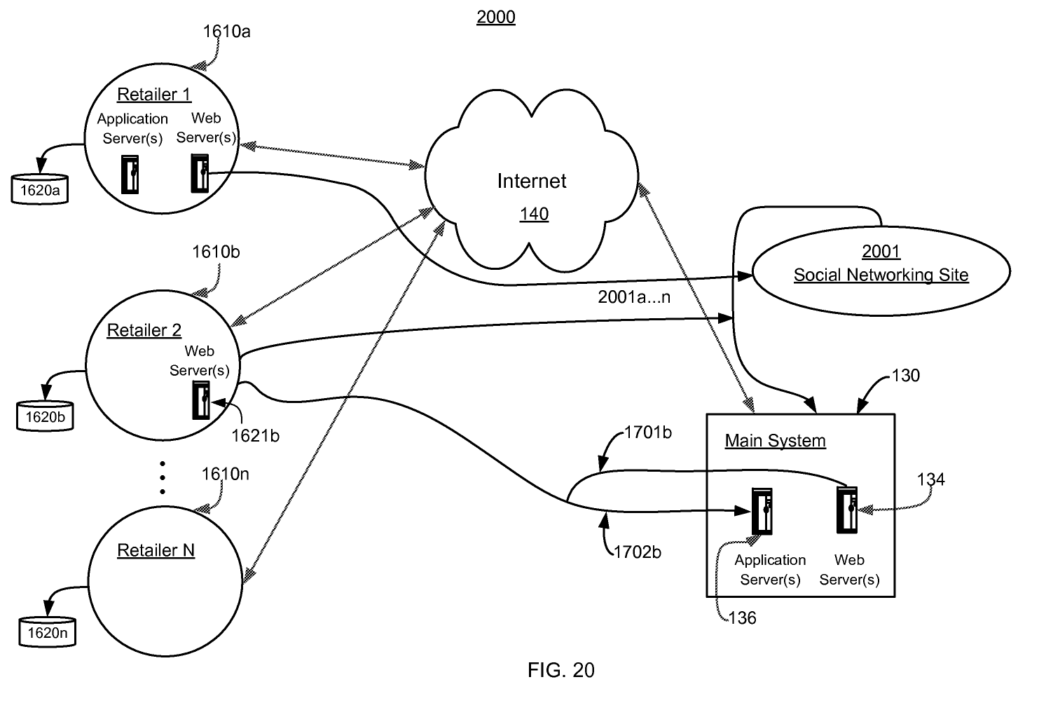

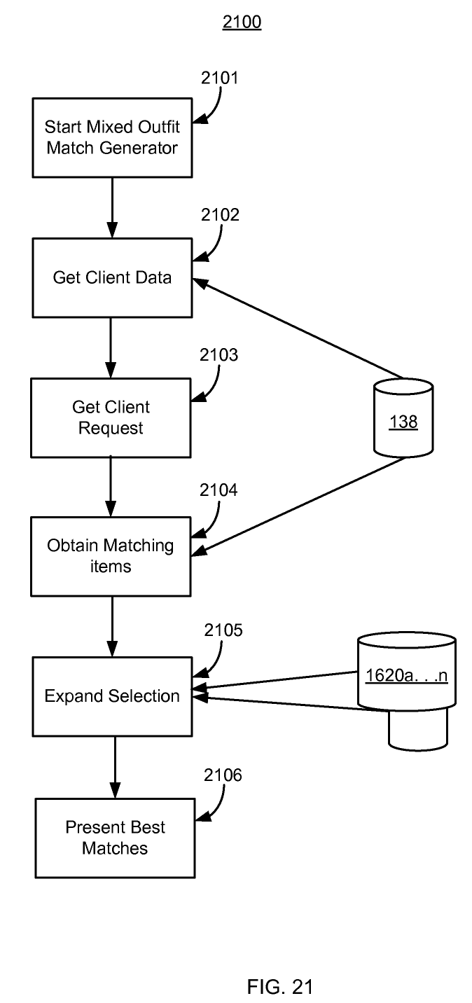

FIGS. 16-21 show an enhanced overview of a multi-partner clothes and accessories, shoes, purses, and all other products that include the notions of fashion and style, shopping system 1600. Further teachings along these lines are provided by Wannier III.

Using such a shopping system, several benefits are provided, such as a system and method for integrating embedded shops on multiple sites, linked to a virtual personal shopping channel where each person can instantly see within their personal shop the clothes and other fashion items that “match” a user's profile and fit and flatter within each node of the network. Those shops can be integrated with social networks and syndication of content for marketing products. The shopping system might generate product combinations from a plurality of inventories at a point of sale for a transaction and a system of soliciting interest in custom-made garments based on user indication, and in some cases including on-line closet representations of consumer-owned items.

The shopping system might allow for shopping of outfits or ensembles of items, allowing users to mix and match on any website or kiosk any part of such an outfit or ensemble, matching to other parts on other websites or items already owned by customer and/or known to the system.

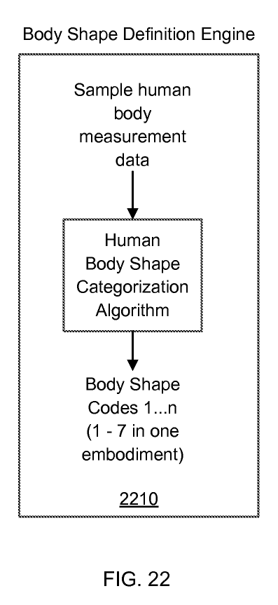

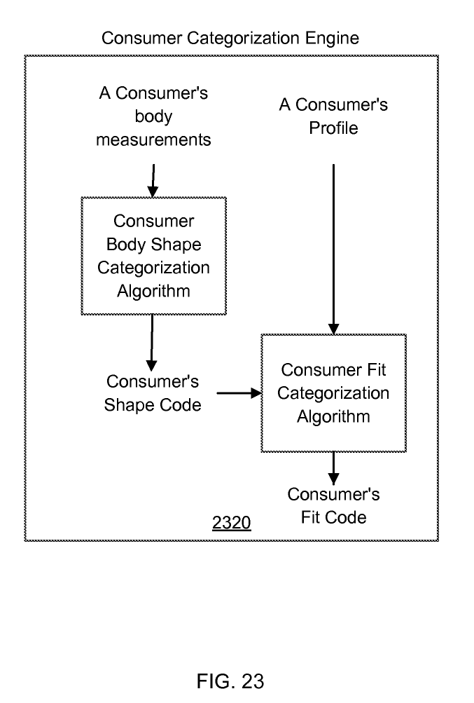

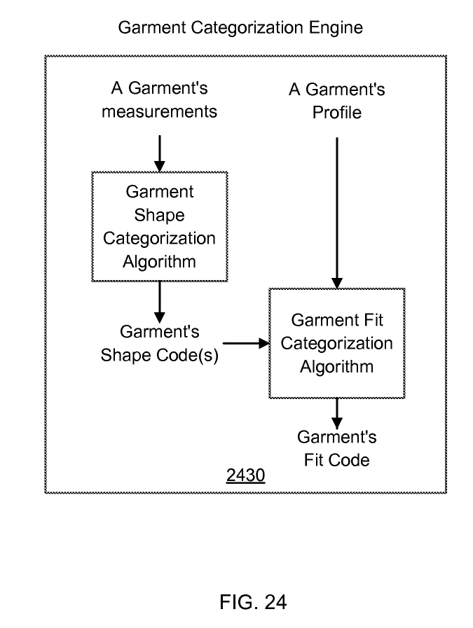

FIGS. 22-24 depict a categorization process 2205 that is described in greater detail in Wannier IV. Individual consumers can be categorized.

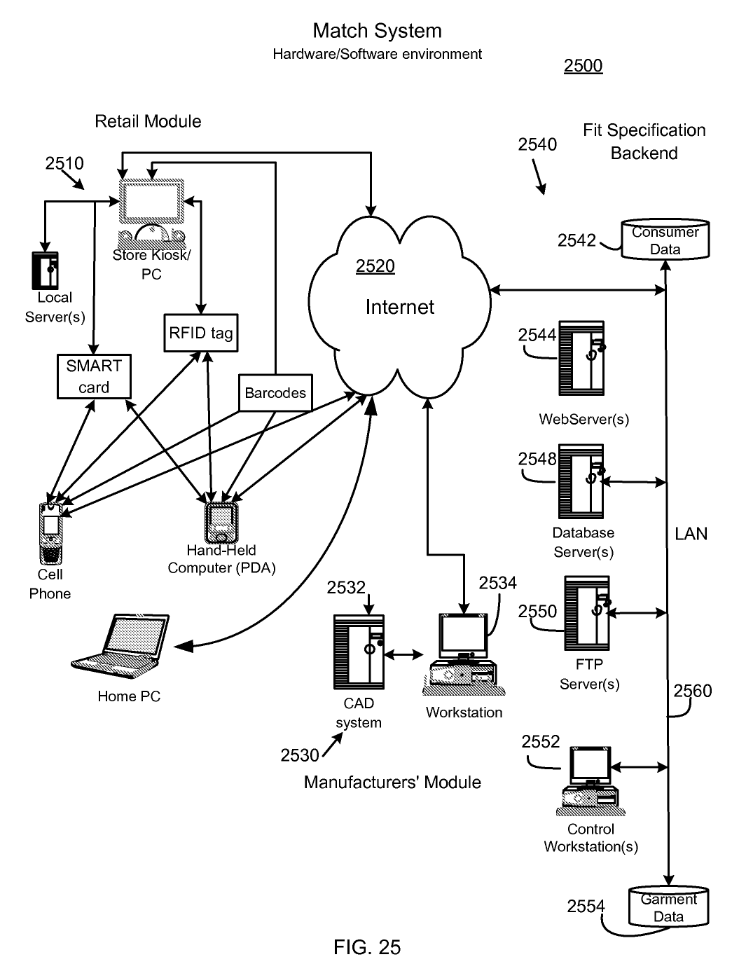

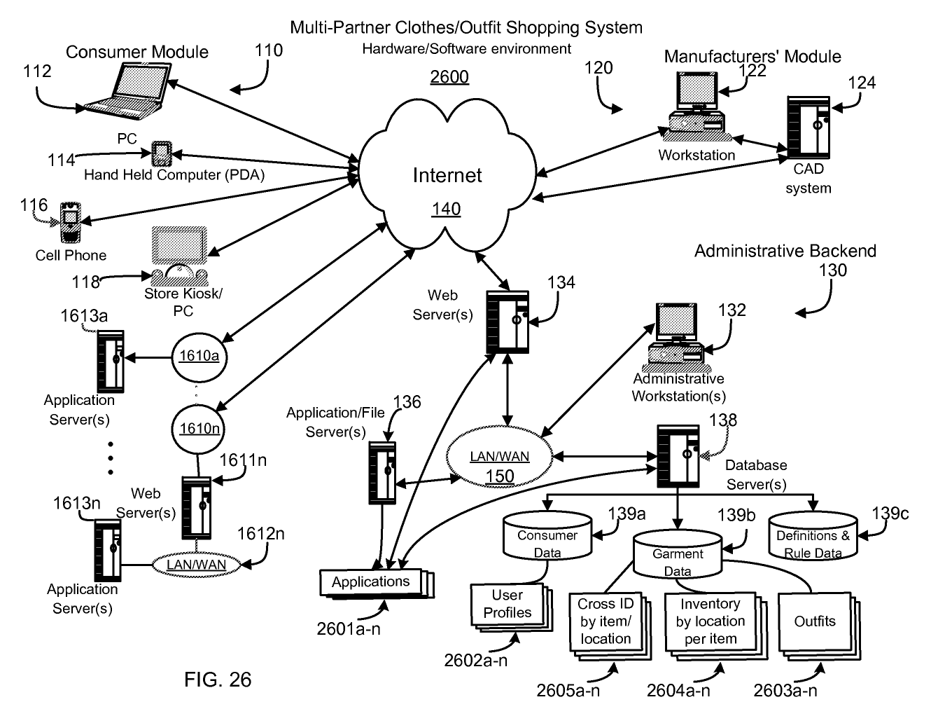

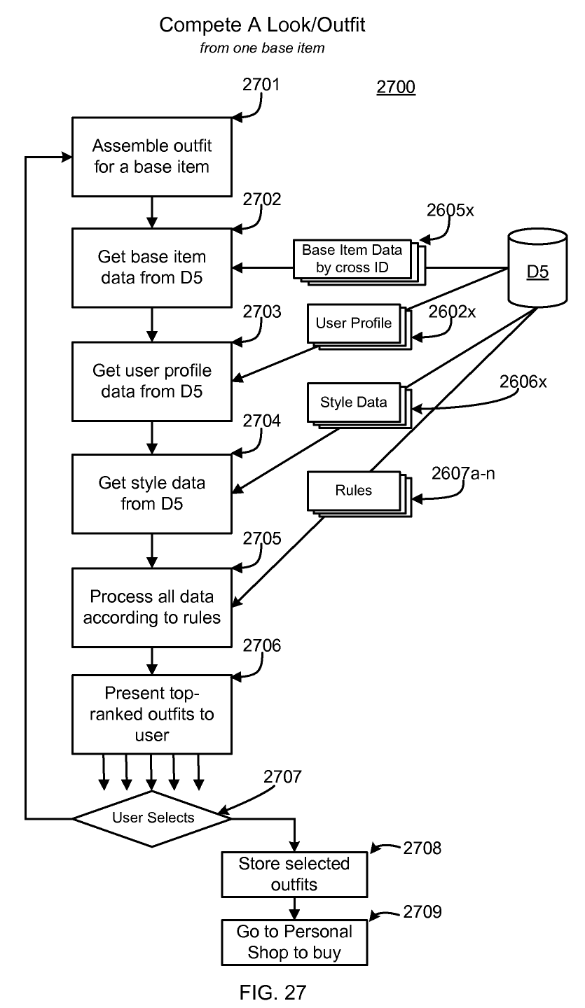

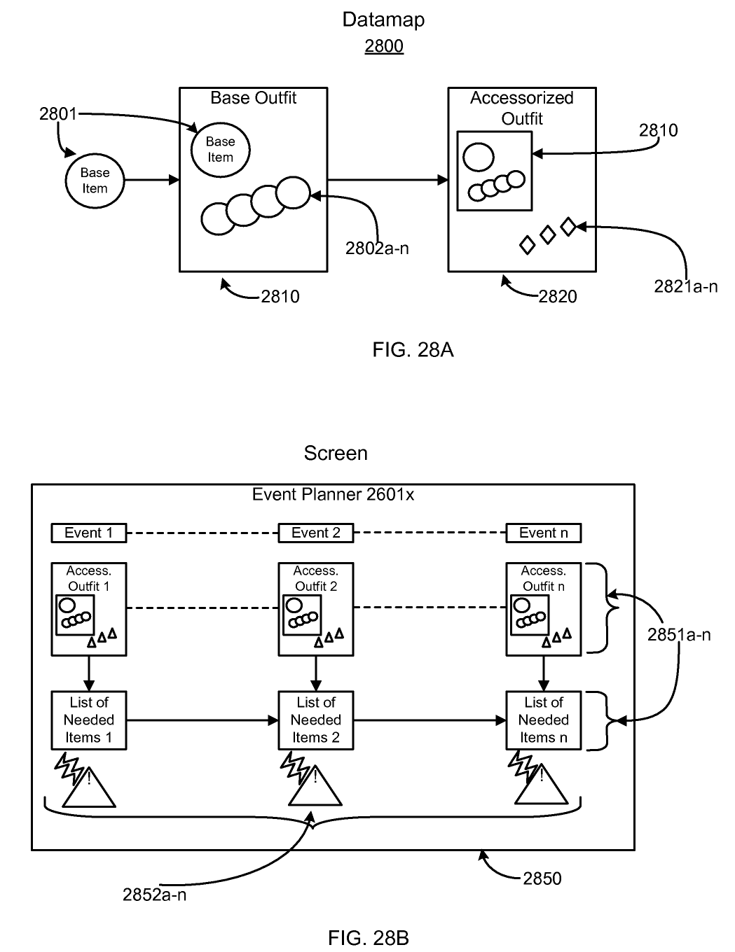

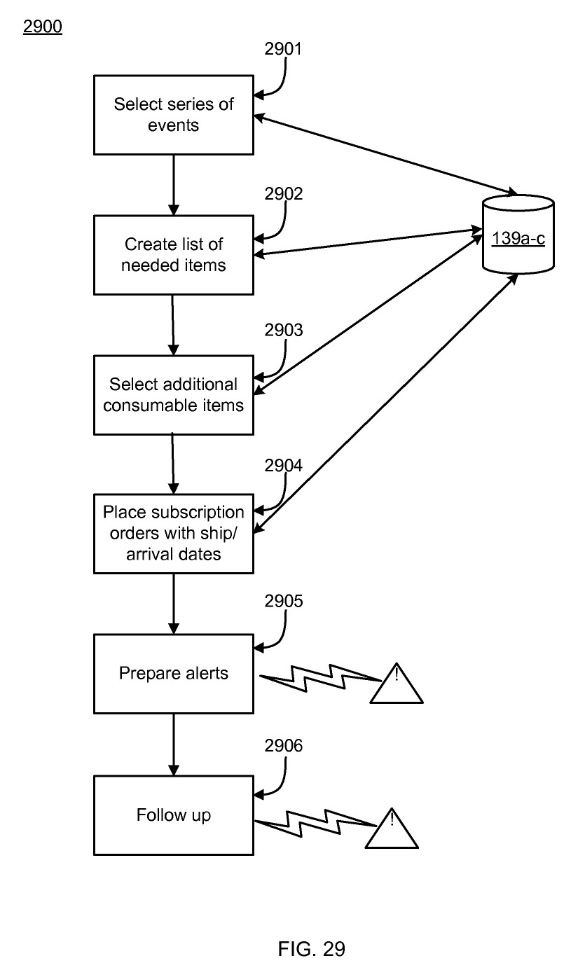

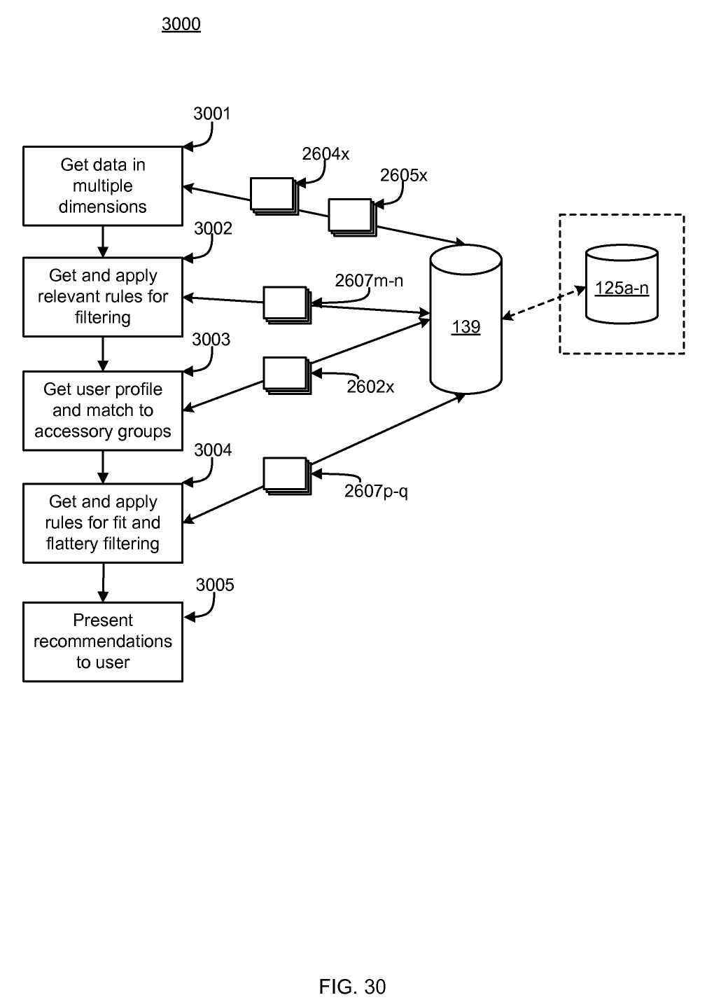

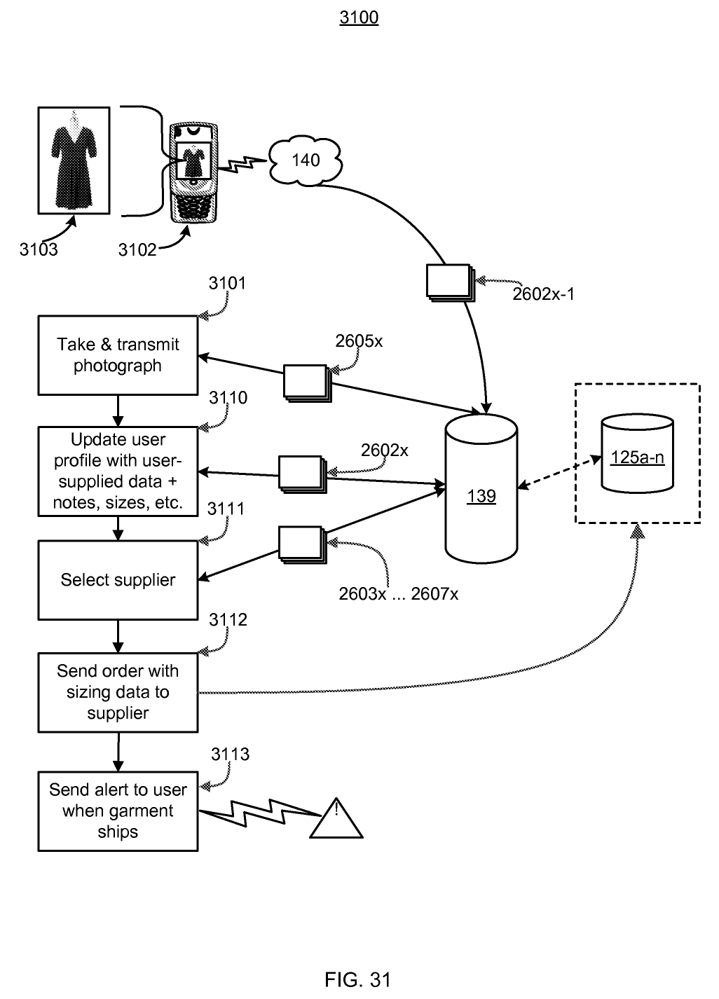

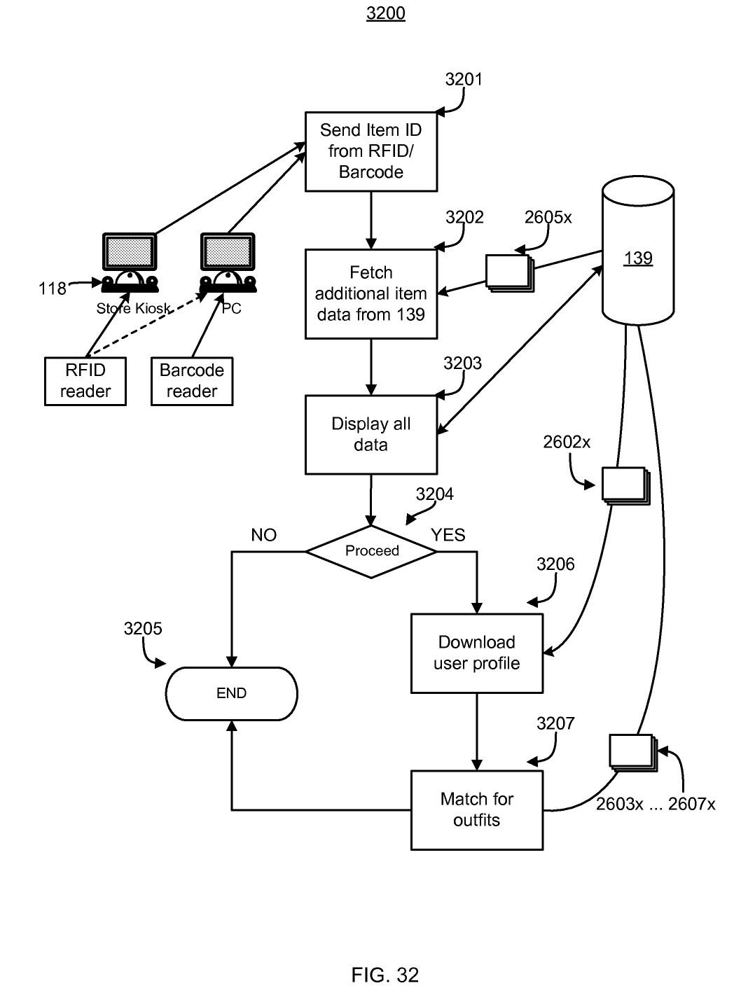

FIGS. 25-32 shows a match system 2500 and processes used to enable a shopping process, each described in greater detail in Wannier IV.

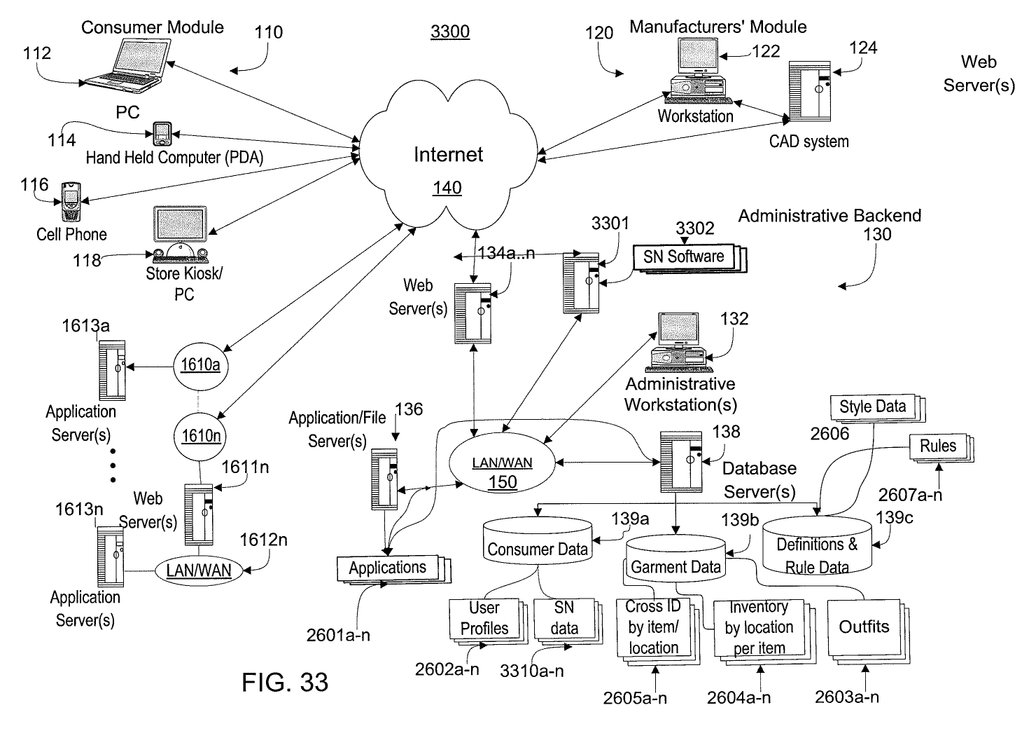

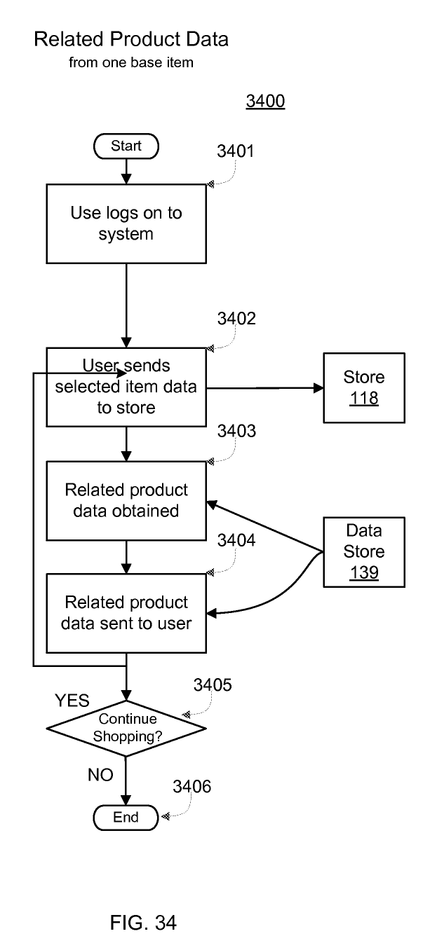

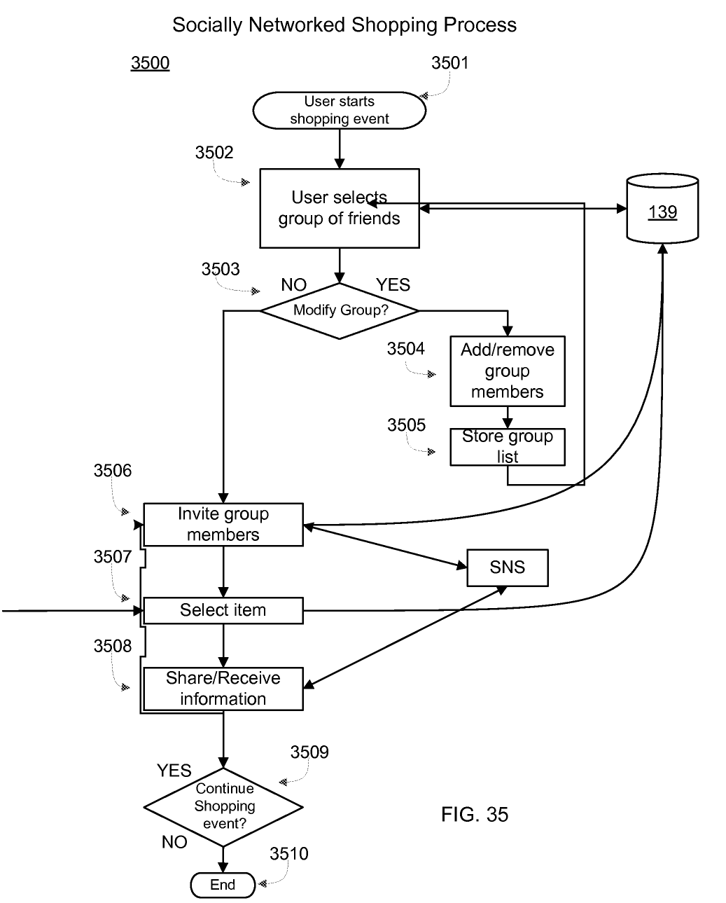

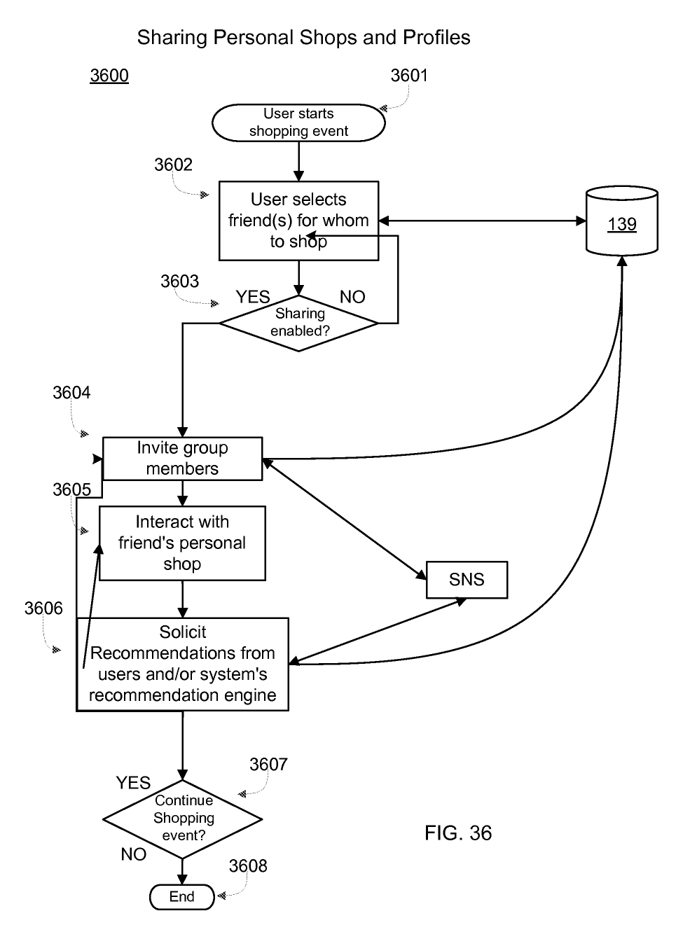

FIGS. 33-36 show a socially networked shopping system 3300 that is described in greater detail in Wannier V.

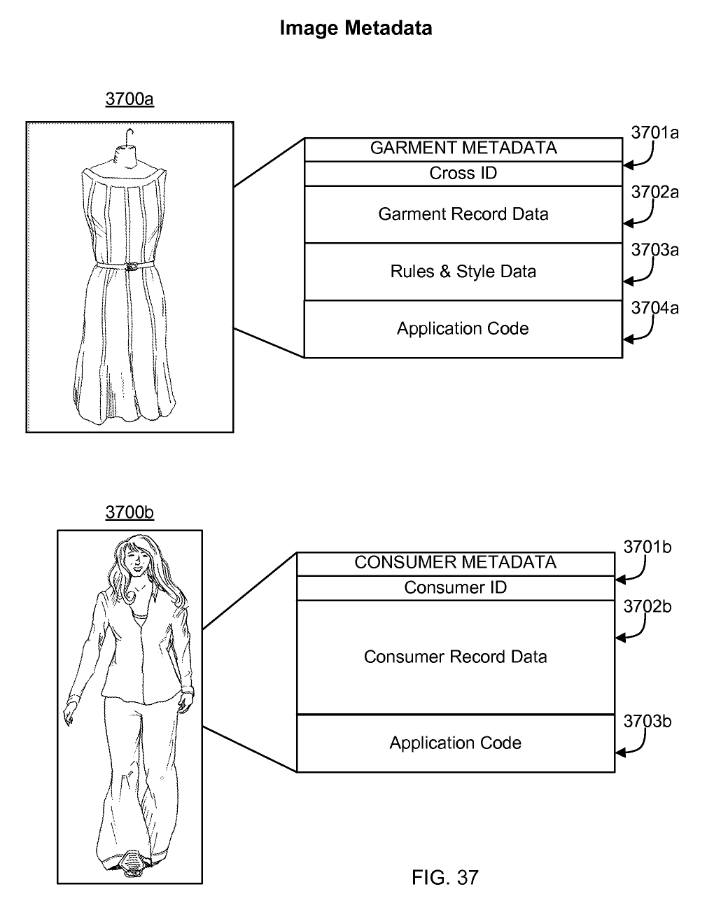

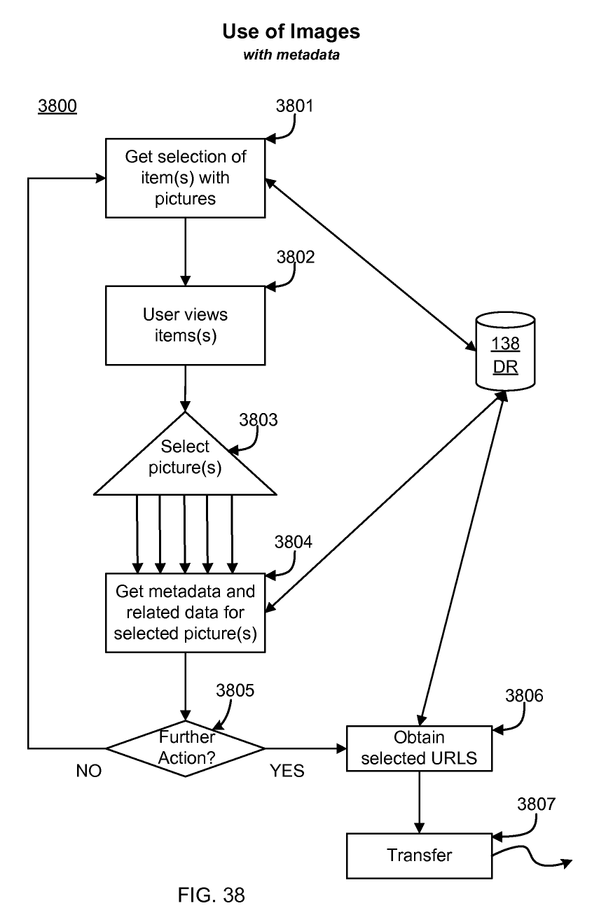

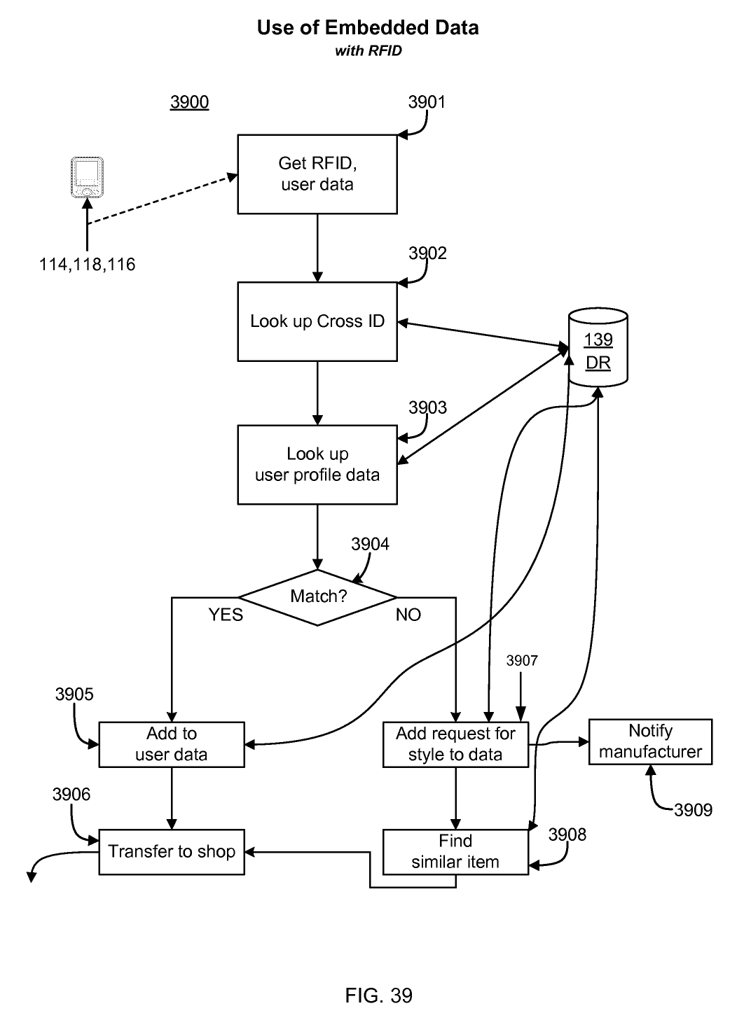

FIGS. 37-39 show a system and method for integrating vendor and buyer information using metadata that is described in greater detail in Wannier VI.

### Identifying and Visually Distinguishing Personally Relevant Items

Among other teachings, a multi-partner shopping system is described that can be used for shopping for clothes and accessories, shoes, purses, and/or other products that include or embody notions of fashion and/or style. In one implementation, content is maintained on servers and served to browsers on request, with some content generated on the fly. The presentation of this material, collectively, by a server having access to the content is often referred to as a “website”, although the “location” of such a site is virtual and often in the minds of the users. Nonetheless, that shorthand is used herein and it should be understood that a website is content served by a physical computing system or a process running on a physical computing system. Likewise, when referring to operations that the “website” does or presents, it should be understood that those operations are performed by a processing device, processor, etc. executing instructions corresponding to the operations or perhaps specialized hardware, firmware or the like.

Online can refer to electronic communications and/or remote access of one computing system or device by another computing system or device, often those having client-server relationships. The access can be over a network of some sort or another. A common example used herein, but not intended to be limiting, is the Internet.

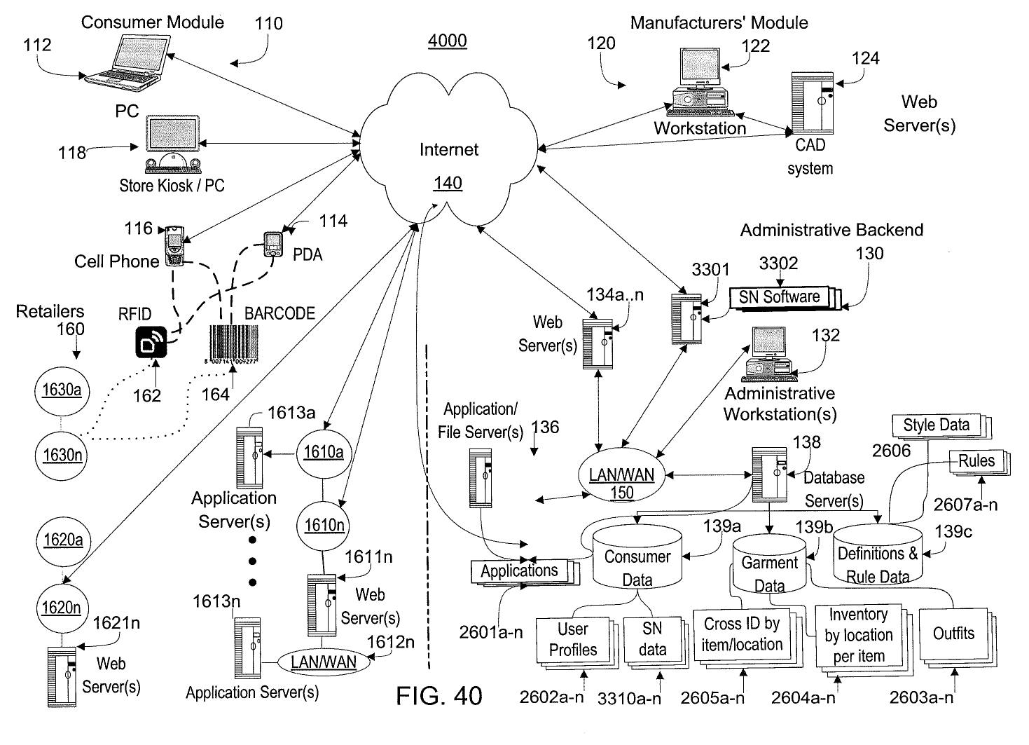

FIG. 40 shows an enhanced overview of a non- and multi-partner shopping system 4000. For purposes of simplicity and clarity, the “personal shop” database system described in the previous issued/co-pending application(s) is presented in a simplified view as database 138, but it is clear that in terms of web systems, complicated multiuser, multiserver systems often may be used to create storage systems. Retailers 160 can include online partner retailers 1610a-n, non-partner retailers 1620a-n and “bricks and mortar” retailers 1630a-n.

In some cases, partner retailers 1610a-n may have their own application servers 1613a-n, their own web servers 1611a-n (some not shown for clarity), and their own internal networks or LANs 1612a-n (some not shown for clarity). This configuration allows partners 1610a-n to connect to the main system 130 so that they can identify items for sale on their own web sites that are personally relevant for shoppers. Non-partnering retailers 1620a-n have their own web servers 1621a-n that need not be connected to main system 130.

In some cases, web server 134 exports lists of matching items and/or differentiated views of items to the web server running at partner retailer 1610n, as indicated through connection 1601n. In other cases, lists of matching items and/or differentiated views of items are delivered by web server 134 directly to a consumer's device, consumer module 110. For both approaches, multiple techniques are well known in the art, including but not limited to VPN tunnels, widgets, or redirection, for example. Many other approaches may be used in Internet-based systems, which approaches deliver similar results and are therefore considered equivalent for the present invention.

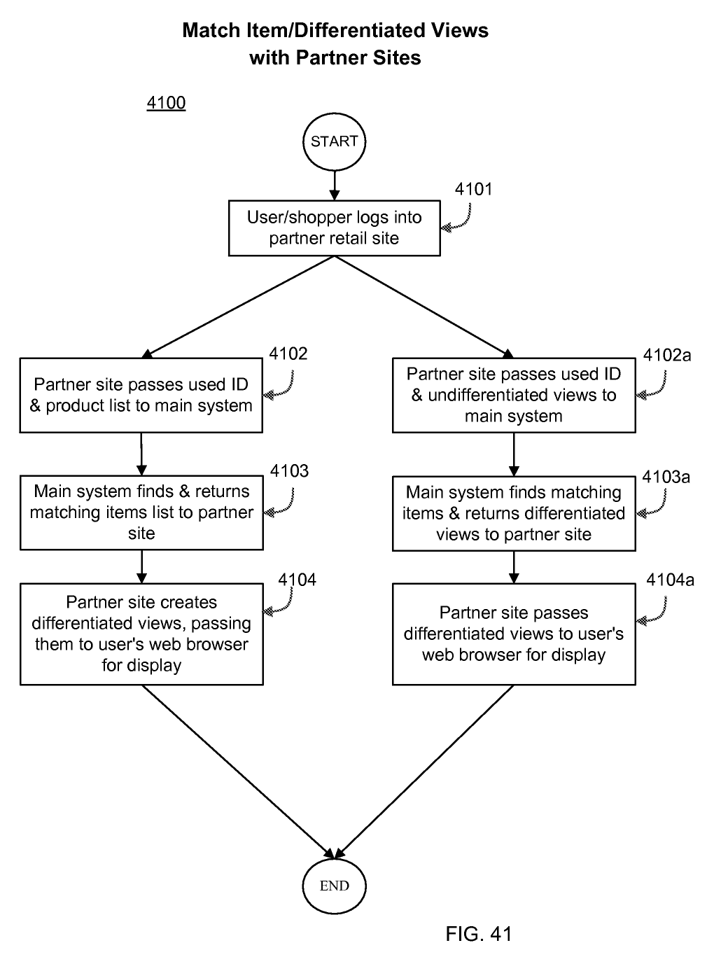

FIG. 41 shows an exemplary process 4100 for creation of matching items lists and/or differentiated views in concert with partner retail sites. In this process, at step 4101, the user/shopper logs into retail partner website 1610a-n. In step 4102, the partner website passes the user's ID and a list of product IDs to main system 130. In step 4103, the system identifies the product items that “match” the user, then web server 134 returns the matching items list to partner server. In step 4104, partner web server creates differentiated views of items and passes them to user's browser for display.

Alternately at step 4102a, partner website passes the user's ID and undifferentiated views of product items to main system 130. In step 4103a, the system identifies product items that “match” the user, creates differentiated views of items, and web server 134 returns the differentiated views to partner server. In step 4104a, partner web server passes differentiated views of items to user's browser for display or, in step 4103b, the system identifies the product items that “match” the user, creates differentiated views of items. In step 4104b, web server 134 returns the differentiated views directly to user's browser for display.

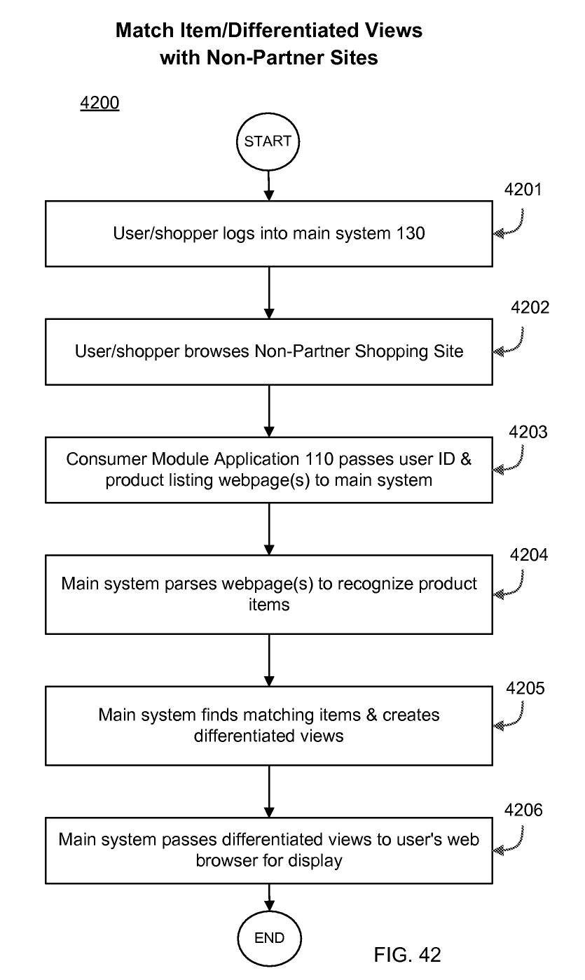

FIG. 42 shows an exemplary process 4200 for creation of differentiated views of non-partner retail sites. In this process, at step 4201, the user/shopper logs into main system 130 via consumer module 110, by adding or enhancing a specialized viewer (for example, including but not limited to, an Adobe™ Flash™ player), a browser plug-in, or in some cases Java or Java-script or AJAX programs, and in yet other cases it could run entirely on the web server, by intercepting results before delivery. In step 4202, a user browses non-partner retail website 1620a-n via a web browser. In step 4203, consumer module application 110 intercepts retailer's product listing web pages at user's browser and passes the web pages to main system 130 along with the user's ID. In step 4204, the main system parses the passed web pages to extract information about product items for sale from the entire set of webpage data. In step 4205, system uses the extracted information that “match” the user to create differentiated views of items. In step 4206, web server 134 returns the differentiated views directly to user's browser for display.

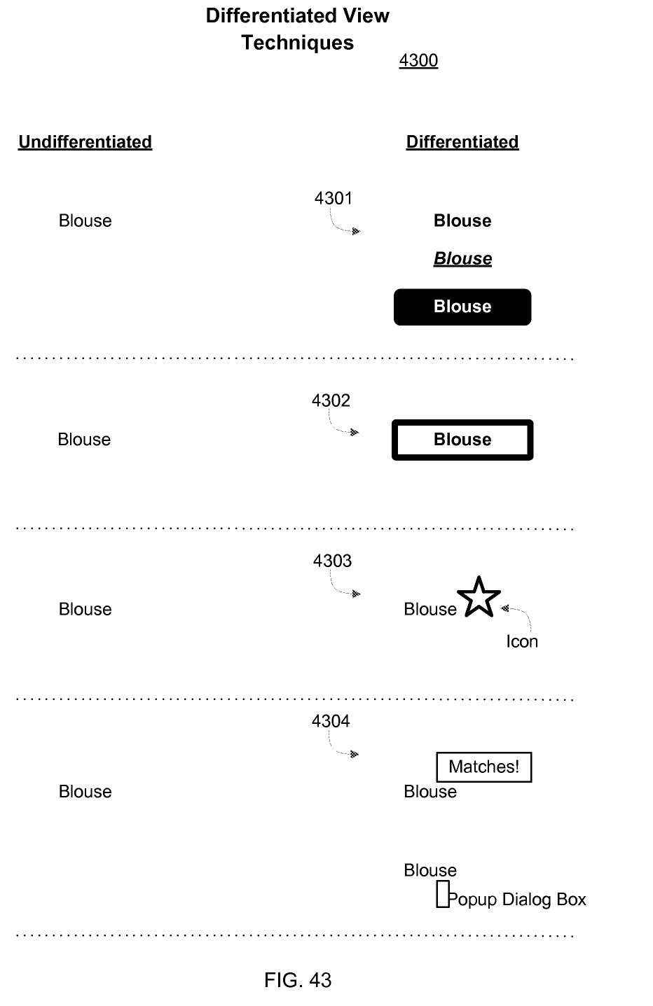

FIG. 43 illustrates exemplary differentiated views. Differentiated display can be, for example, anything where matching items are shown one way and non-matches are shown a different way, such that the user can tell the difference or the user's browser can tell the difference. Items deemed to be matching could be shown contextually, in a positive light, where as non-matching items could, for example, be shown isolated, or in a negatively associated context, lighting, etc.

A variety of graphical techniques are known to indicate difference including, but not limited to, variation of typeface, typestyle, typesize & typecolor, fore- and background shadings 4301, borders 4302, grouping by screen location, contextualization and visual elements (icon, cursor, badge, logo, etc.) 4303. Also a variety of interactive techniques are known to indicate difference including, but not limited to, text tooltips, popup dialog boxes, animations, audio/visual alerts, etc 4304. It is clear that many modifications and variations of differentiated views may be made by one skilled in the art without departing from the spirit of the novel art of this disclosure and the examples cited here are to be regarded in an illustrative rather than a restrictive sense.

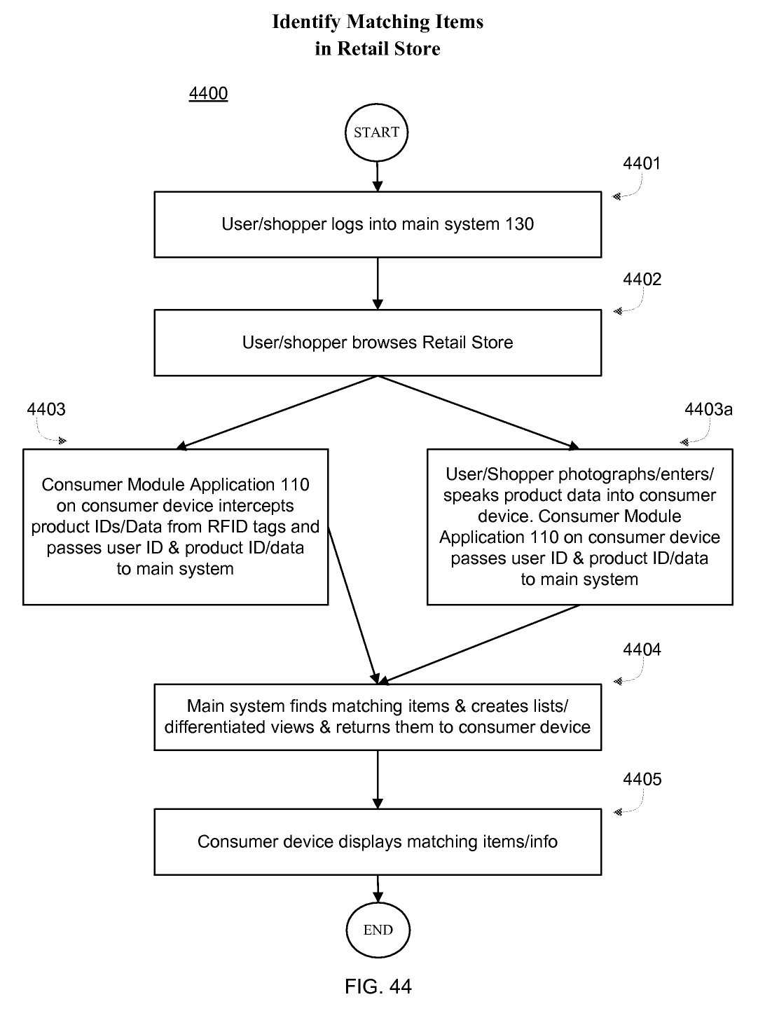

FIG. 44 shows an exemplary process 4400 for identifying items for sale in a physical “bricks and mortar” store that are personally relevant to the shopper. In this process, at step 4401, the user/shopper logs into main system 130 via consumer module application 110 on user's device such as mobile phone 116 or PDA 114. In step 4402, the user/shopper browses the aisles of the retail store 1630a-n. In step 4403, consumer module application 110 intercepts signals from RFID tags or other electronic data sources such as smart textiles affixed to, or embedded in, product items and passes product IDs and/or other embedded product data such as measurements, shape, profile, etc. to main system 130 along with the user's ID. In step 4404, the system identifies the product items that “match” the user and web server 134 returns the matching items list to consumer device. In step 4405, consumer's device displays views of items that “match” the shopper's profile. Additionally audible tones or vocalizations may notify the shopper that she is in proximity to matching items and guide her to them. Additionally Store Kiosk/PC 118 may be used to display and/or print further information such as a site map or floor plan (both for virtual and physical stores) indicating where the shopper can locate matching items.

Alternately in step 4403a, the shopper photographs a product's barcode or enters a product's ID, such as a UPC code, via a keyboard or voice entry mechanism on her consumer device. The consumer module application 110 passes the product's identifying data to main system 130 along with the user's ID. The process then continues to step 4404 as before. And again in step 4405, consumer's device displays views of items that “match” the shopper's profile, so that she can quickly find the items, clothes and fashion products that fit, suit and flatter her.

Further embodiments can be envisioned to one of ordinary skill in the art after reading this disclosure.

In some embodiments, the matching is done based on information maintained at the merchant and in others it is separate. In some cases, the matching criteria might include other items. Thus, instead of differentially showing all items that match the user's personal preference relative to those that don't, the user might designate a reference item (such as a dress, shoes or purse) and all items that match the user's personal preference and go together with the reference item are shown visually one way and those items that either don't match the user's personal preference or don't go together with the reference item are not shown in that visual way. They can be collectively shown in another way, or there can be up to four differential display ways (items that match preferences and go with the reference, items that don't match but go with the reference, items that match preferences but don't go with the reference, and items that neither match nor go). In some instances, what goes and does not go with a reference can be done programmatically following rules, or done manually.

In some embodiments, a display system interfaces to a user's browser, a web server serves views of items for sale and a personal shop server is distinct from the web server, wherein the user's browser is provided with differentiated views of items that signal to the user whether or not a particular item is within the user's personal shop. Differential display can be anything where matches are shown one way and nonmatches are shown a different way, such that the user can tell the difference or the user's browser can tell the difference. There might be more than one way to show nonmatches.

The differentiation might be done by having the user's browser (or other mechanism) provide the personal shop server with item parameters, having the user identified to the personal shop server, and having the personal shop server having access to user parameters, thereby allowing the personal shop server to determine matches between the identified user and the items available at the web server. The item parameters might include measurements, shape, profile, etc. The user parameters might include measurements, shape, profile, etc. Differentiated views might be different shadings for items that match versus items that do not match. Differentiated views might be provided as the user selects (by click, mouse roll-over, etc.) items and otherwise not provided. The user might be provided with an on-screen element (icon, cursor, badge, logo, etc.) for use in the process of discovering which displayed items match or don't match. Logic at the browser might be present to extract item parameters from the website and extract user parameters from the user's computer (or user parameters by reference to data stored at the personal shop server) for a comparison process. Logic at the browser might be present to modify web pages provided by the web server so that the modified pages present the differentiated views where the unmodified pages would not.

All of the above might be done where, but instead of a browsing a website, the user is browsing physical inventory using a device that extracts item parameters from the items and differentially displays whether the item is a match. An example device is a badge, RFID tag, wand, decoder ring, etc.

In some embodiments, the system is conducting match assessment on the fly when a user is presented with one or more items, some of which match and some of which do not match, and indicating the matches using a differential signaling/display/labeling.

The matching can be exact matching or approximate matching and may include filtering out nonmatching items.

In some embodiments, the website being viewed is not set up to be filtered and cannot be modified for differential display. If modifications are allowed, incoming web pages can be modified to remove references to items that do not match instead of displaying them with the “nonmatch” differential display. This works well where the website has no login feature or does not have user accounts such that users cannot customize the pages.

In other embodiments, combinations or sub-combinations of the above disclosed invention can be advantageously made. The example arrangements of components are shown for purposes of illustration and it should be understood that combinations, additions, re-arrangements, and the like are contemplated in alternative embodiments of the present invention. Thus, while the invention has been described with respect to exemplary embodiments, one skilled in the art will recognize that numerous modifications are possible.

For example, the processes described herein may be implemented using hardware components, software components, and/or any combination thereof. The specification and drawings are, accordingly, to be regarded in an illustrative rather than a restrictive sense. It will, however, be evident that various modifications and changes may be made thereunto without departing from the broader spirit and scope of the invention as set forth in the claims and that the invention is intended to cover all modifications and equivalents within the scope of the following claims.

1. An online shopping system comprising:
data storage for a database of items, wherein the database of items includes characteristics for at least a plurality of items in the database, wherein at least some of the plurality of items are items for purchase, rent or acquisition by, or on behalf of, a current consumer;
data storage for a consumer record, wherein the consumer record includes data elements comprising personal shop details for at least the current consumer;
logic for matching at least one item of the database of items, the matching being done between the stored characteristics of the at least one item and the personal shop details of a current consumer, wherein the logic for matching applies matching criteria to determine if the at least one item matches the personal shop details of the current consumer, and further wherein the logic for matching identifies at least one item that does not meet the matching criteria; and
a display, coupled to the logic for matching, for displaying at least images or text representing a plurality of the items in the database, wherein the items that the logic for matching determines matches the matching criteria are displayed distinguishably relative to the items that the logic for matching determines do not match the matching criteria.

2. The online shopping system of claim 1, wherein the personal shop details include one or more of a personal shop preference determined based on a user profile of the current consumer, a personal shop fit profile of the current consumer, a personal shop figure profile of the current consumer, a personal shop styling profile of the current consumer, and/or a fashion expertise attribute, wherein the personal shop profiles are stored as part of the consumer record for the current consumer.

3. The online shopping system of claim 2, wherein the personal shop preference is determined based on the current consumer's user fashion preferences, as stored in the consumer record for the current consumer.

4. The online shopping system of claim 1, wherein the personal shop details stored in a consumer record and used by the logic for matching comprise a fit profile, a user preference, a user body shape indicator, and user style preferences.

5. The online shopping system of claim 1, wherein the data storage for the consumer record, the logic for matching and the display are implemented in a portable device operated by the consumer or consumer representative, and wherein the data storage for the database of items is remote from the portable device and accessible over a network.

6. The online shopping system of claim 1, wherein the data storage for the database of items is local to the consumer or consumer representative.

7. The online shopping system of claim 1, wherein the data storage for the database is adapted to be available at a point of acquisition consideration and is associated with items physically visible to the consumer or consumer representative along with a portable device operated by the consumer or consumer representative that includes the data storage for the consumer record, the logic for matching and the display.

8. The online shopping system of claim 1, wherein the items that the logic for matching determines matches the matching criteria are visually displayed distinguishably relative to the items that the logic for matching determines do not match the matching criteria.

9. The online shopping system of claim 1, wherein the items that the logic for matching determines matches the matching criteria are displayed with distinguishing text relative to the items that the logic for matching determines do not match the matching criteria.

10. The online shopping system of claim 1, further comprising an input on a device providing the display and logic to eliminate a view of the items that the logic for matching determines do not match the matching criteria, when the consumer or consumer representative selects an input to filter out unmatching items.

11. An online shopping system comprising:
data storage for a database of items, wherein the database of items includes characteristics for at least a plurality of items in the database, wherein at least some of the plurality of items are items for purchase, rent or acquisition by, or on behalf of, a current consumer;
data storage for a consumer record, wherein the consumer record includes data elements comprising personal shop details for at least the current consumer;
logic for matching at least one item of the database of items, the matching being done between the stored characteristics of the at least one item and the personal shop details of a current consumer, wherein the logic for matching applies matching criteria to determine if the at least one item matches the personal shop details of the current consumer, and further wherein the logic for matching identifies at least one item that does not meet the matching criteria; and
an output for display data, coupled to the logic for matching, such that the display data output is configured such that, when displayed, at least images or text representing a plurality of the items in the database would be displayed and displayed such that the items that the logic for matching determines matches the matching criteria would be expected to be displayed distinguishably relative to the items that the logic for matching determines do not match the matching criteria.
